(19) United States
(12) Patent Application Publication
(10) Pub. No.: US 2023/0021435 A1
(43) Pub. Date: Jan. 26, 2023

(54) Method And System For Distributing Content By Pre-Positioning And Redistributing The Content To Other Devices

(71) Applicant: Siden, Inc., New York, NY (US)

(72) Inventors: Narayan Parappil MENON, Syosset, NY (US); Boris BOGATIN, Glenside, PA (US)

(21) Appl. No.: 17/869,213

(22) Filed: Jul. 20, 2022

Related U.S. Application Data
(60) Provisional application No. 63/225,475, filed on Jul. 24, 2021.

(51) Int. Cl. H04W 72/04; H04W 24/02; H04W 84/12

(52) U.S. Cl. CPC H04W 72/042; H04W 24/02; H04W 84/12

(57) ABSTRACT

A system and method of operating a content distribution system includes receiving and storing a first content at a first storage device; communicating the first content from the first storage device to a second storage device through a local area network, said second storage device downstream from the first storage device. The method also includes storing the first content in the second storage device; requesting the first content at a first user device, and communicating the first content from the second storage device to a first user device when requested by the first user device. Other embodiments of this aspect include corresponding computer systems, apparatus, and computer programs recorded on one or more computer storage devices, each configured to perform the actions of the methods.

### CROSS-REFERENCE TO RELATED APPLICATIONS

This is a non-provisional application of provisional application 63/225,475 filed on Jul. 24, 2021, the disclosure of which is incorporated by reference herein. This application incorporates by reference herein the entire disclosures of applications, 63/51,582, filed on Jul. 14, 2020, U.S. Ser. No. 63/50,699, filed on Jul. 10, 2020, U.S. Ser. No. 17/542,582 filed on Dec. 6, 2021, U.S. Ser. No. 17/580,817, filed on Jan. 21, 2022, U.S. Ser. No. 17/700,436, filed on Mar. 21, 2022, U.S. Ser. No. 17/741,301, filed on May 10, 2022, U.S. Ser. No. 17/095,686, filed on Nov. 11, 2020, U.S. Ser. No. 16/588,763, filed Sep. 30, 2019, U.S. Ser. No. 17/489,912, filed on Sep. 30, 2021, U.S. Pat. No. 10,433,22, issued on Oct. 1, 2019 and U.S. Ser. No. 17/353,989, filed Jun. 22, 2021.

### TECHNICAL FIELD

The present disclosure relates generally to content distribution systems and, more specifically, to a method and system for pre-positioning and post positioning content in various locations within the network.

### BACKGROUND

The statements in this section merely provide background information related to the present disclosure and may not constitute prior art.

The provisioning of increasingly higher speed wireless data connectivity has been the focus of wireless carrier infrastructure growth for several decades and has accelerated with the rapidly rising demand by consumers to stream video to each or any of their devices, irrespective of where they are. The increasing wireless performance, together with both users' desires to consume more bandwidth intensive video content over the Internet, at lower marginal cost per bit, and wireless providers desire to serve more of the users' demands including in the home and also to large screen devices (i.e., TVs, laptops), is placing a requirement on wireless networks to accommodate a markedly higher level of capacity for handling this exploding video data traffic demand over wireless networks.

Further, wireless networks are still approaching video distribution using traditional means, which can be improved upon. Today, video data traffic is carried over wireless networks at the same time, as when consumers desire to consume such video data traffic. Since consumers consume data traffic at times driven largely by social structures, with significant consumption happening at the same time across the consumer base including during “prime time” hours, time intervals of significant “peak” consumption are typical and wireless networks often have insufficient capacity to handle such peak loads. Further, consumers mostly consume different content than other consumers at any given point of time, precluding efficient use of broadcasting content to users for real-time consumption (since has low relevance) outside of select live content (i.e., sports events, time-scheduled releases of popular shows).

However, consumers consume largely the same long-form content (i.e., blockbuster movies and hit TV series) as other consumers, over a longer period of time, so it is possible to “predict” what a consumer would consume with higher accuracy if the real-time requirement were relaxed to “over 3 months” or some other such longer than real-time timeframe. A system that identifies the content generally desired by consumers, that broadcasts such content over the networks in advance of the time it is desired to be consumed by consumers and during such times when the wireless networks have “spare capacity” not needed for real-time traffic needs, that stores such content locally at the consumers' premises, and serves such content to consumers over an unconstrained medium (i.e., home WiFi network), would be able to relieve wireless networks from significant amount of video data content and corresponding congestion.

The scheme provides major benefits to the end user as well as the service provider. This gives the end user access to cached content and data, that the user can consume without using up primetime network bandwidth. This is even more valuable in scenarios where users' data usage is capped, and otherwise receiving content real-time, using primetime network bandwidth, can result in high cost to users; or in regions where broadband bandwidth is insufficient to provide content delivery to large numbers of users.

Dormant capacity management and content pre-positioning enables the service provider to deliver services to users, using dormant network capacity, without passing on a high cost to users. This is possible since the service provider is not leveraging primetime network resources (e.g., precious radio resources in a wireless network) to deliver the service. Large-scale content and data delivery to users is possible at a nominal cost.

At the same time, the provider is able to utilize their idle capacity completely (something they have paid for and is “sunk cost”), and keep network resources occupied throughout the day.

Last, but not least, later local consumption (over a local network such as home WiFi or Ethernet) delivers significantly improved quality of service to the end user. Since the device does not need to livestream from deep within the network, quality of service metrics such as latency, jitter and throughput are vastly improved.

Using dormant network capacity to pre-position non real-time content on storage devices, and end user devices consuming the content from the intermediate devices subsequently over local network connections, has been described by the present Applicant.

### SUMMARY

The present disclosure provides a system and method for strategically using storage devices strategically to reduce system resources in providing content to users.

The current invention extends the concept to local networks, enabling intermediate storage to distribute content to any other target devices (other intermediate storage devices, end-user devices) that are in the vicinity of the source storage device.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect, a method includes receiving and storing a first content at a first storage device; communicating the first content from the first storage device to a second storage device through a local area network, said second storage device downstream from the first storage device. The method also includes storing the first content in the second storage device; requesting the first content at a first user device, and communicating the first content from the second storage device to a first user device when requested by the first user device. Other embodiments of this aspect include corresponding computer systems, apparatus, and computer programs recorded on one or more computer storage devices, each configured to perform the actions of the methods.

Implementations may include one or more of the following features. The method where communicating the first content from the first storage device to the second storage device may include communicating the first content to the second storage device using dormant local network capacity. Using dormant local network capacity may include using available capacity on the local area network that is unused by user traffic. Using dormant local network capacity may include using a separate radio resource. Communicating the first content to the second storage device may include communicating the first content to a plurality of downstream storage devices. Communicating the first content to the second storage device may include communicating the first content to a plurality of downstream storage devices using dormant local network capacity. Communicating the first content from the second storage device to the first user device when requested by the first user device may include communicating the first content from the second storage device to the first user device through a plurality of local area networks when requested by the first user device. Communicating the first content from the first storage device to the second storage device through the local area network may include communicating the first content from the first storage device to the second storage device through at least one of wi-fi, Bluetooth®, multi-media over coax, ethernet and cable. Communicating the first content from the first storage device to the second storage device through the local area network may include communicating the first content from the first storage device to the second storage device using a hidden service set identifier. Prior to receiving and storing the first content at the first storage device, unicasting the content to the first storage device. Prior to receiving and storing the first content at the first storage device, multicasting the content to the first storage device. Prior to receiving and storing the first content at the first storage device, broadcasting the content to the first storage device. Prior to broadcasting determining a modulation and coding scheme based on an aggregate throughput and a number of downstream devices reachable by first storage device. Broadcasting may include broadcasting the content to the first storage device based on the target spectral efficiency. Broadcasting may include broadcasting the content to the first storage device based on the target spectral efficiency and an average capacity in cells of a service area. Communicating the first content from the first storage device to the second storage device through the local area network may include initiating communicating the first content from the first storage device to the second storage device through the local area network from the first storage device. Communicating the first content from the first storage device to the second storage device through the local area network may include initiating communicating the first content from the first storage device to the second storage device through the local area network from the second storage device. Communicating the first content from the first storage device to the second storage device through the local area network may include initiating communicating the first content from the first storage device to the second storage device through the local area network from a content distribution system. Initiating communicating the first content from the first storage device to the second storage device through the local area network from the content distribution system may include determining wanted content of the second storage device at the content distribution system and initiating communicating the first content based on the wanted content. The method may include communicating a discovery request for wanted content from the user device within the local area network and generating a response signal from the second storage device when the wanted content is disposed therein. The method may include communicating a discovery request for wanted content from the user device to outside the local area network and generating a response signal from a third storage device when the wanted content is disposed therein. The method may include managing communicating the first content from the second storage device using an over-the-top protocol. Communicating the first content from the first storage device to the second storage device may include communicating the first content from a first intermediate storage device to a second intermediate storage device through a local network. Communicating the first content from the first storage device to the second storage device may include communicating the first content from a first intermediate storage device in a first local area network to a second intermediate storage device in a second local network. Communicating the first content from the first storage device to the second storage device may include communicating the first content from a first intermediate storage device in a first local area network to a second intermediate storage device in the first local area network. Communicating the first content from the first storage device to the second storage device may include communicating the first content from a first intermediate storage device to a second intermediate storage device through a local network using dormant local network capacity. Communicating the first content from the first storage device to the second storage device may include communicating the first content from a first intermediate storage device to a plurality of intermediate storage devices through a local network. Communicating the first content from the first storage device to the second storage device may include communicating the first content from a first intermediate storage device in a first local area network to a plurality of intermediate storage devices in a second local area network. Communicating the first content from the first storage device to the second storage device may include communicating the first content from a first intermediate storage device in a first local area network to a plurality of intermediate storage devices in the first local area network. Communicating the first content from the first storage device to the second storage device may include communicating the first content from a first intermediate storage device to a plurality of intermediate storage devices through a local network using dormant local network capacity. Communicating the first content from the first storage device to the second storage device may include communicating the first content from a first intermediate storage device to an end user device through a local network. Communicating the first content from the first storage device to the second storage device may include communicating the first content from a first intermediate storage device in a first local area network to an end user device in a second local network. Communicating the first content from the first storage device to the second storage device may include streaming the first content from a first intermediate storage device in a first local area network to an end user device in a second local network. Communicating the first content from the first storage device to the second storage device may include communicating the first content from a first intermediate storage device in a first local area network to an end user device in the first local area network. Communicating the first content from the first storage device to the second storage device may include streaming the first content from a first intermediate storage device in a first local area network to an end user device in the first local area network. Communicating the first content from the first storage device to the second storage device may include communicating the first content from a first intermediate storage device to an end user device through a local network using dormant local network capacity. Communicating the first content from the first storage device to the second storage device may include communicating the first content from a first intermediate storage device to a plurality of end user devices through a local network. Communicating the first content from the first storage device to the second storage device may include communicating the first content from a first intermediate storage device in a first local area network to a plurality of end user devices in a second local area network. Communicating the first content from the first storage device to the second storage device may include streaming the first content from a first intermediate storage device in a first local area network to a plurality of end user devices in a second local area network. Communicating the first content from the first storage device to the second storage device may include communicating the first content from a first intermediate storage device in a first local area network to a plurality of end user devices in the first local area network. Communicating the first content from the first storage device to the second storage device may include streaming the first content from a first intermediate storage device in a first local area network to a plurality of end user devices in the first local area network. Communicating the first content from the first storage device to the second storage device may include communicating the first content from a first intermediate storage device to a plurality of end user devices through a local network using dormant local network capacity. Communicating the first content from the first storage device to the second storage device may include communicating the first content from a first end user device to a second end user device through a local network. Communicating the first content from the first storage device to the second storage device may include communicating the first content from a first end user device in a first local area network to a second end user device in a second local network. Communicating the first content from the first storage device to the second storage device may include streaming the first content from a first end user device in a first local area network to a second end user device in a second local network. Communicating the first content from the first storage device to the second storage device may include communicating the first content from a first end user device in a first local area network to a second end user device in the first local area network. Communicating the first content from the first storage device to the second storage device may include streaming the first content from a first end user device in a first local area network to a second end user device in the first local area network. Communicating the first content from the first storage device to the second storage device may include communicating the first content from a first end user device to a second end user device through a local network using dormant local network capacity. Communicating the first content from the first storage device to the second storage device may include communicating the first content from a first end user device to a plurality of end user devices through a local network. Communicating the first content from the first storage device to the second storage device may include communicating the first content from a first end user device in a first local area network to a plurality of end user devices in a second local area network. Communicating the first content from the first storage device to the second storage device may include streaming the first content from a first end user device in a first local area network to a plurality of end user devices in a second local area network. Communicating the first content from the first storage device to the second storage device may include communicating the first content from a first end user device in a first local area network to a plurality of end user devices in the first local area network. Communicating the first content from the first storage device to the second storage device may include streaming the first content from a first end user device in a first local area network to a plurality of end user devices in the first local area network. Communicating the first content from the first storage device to the second storage device may include communicating the first content from a first end user device to a plurality of end user devices through a local network using dormant local network capacity. Communicating the first content from the first storage device to the second storage device may include communicating the first content from an end user device to an intermediate storage device through a local network. Communicating the first content from the first storage device to the second storage device may include communicating the first content from an end user device in a first local area network to an intermediate storage device in a second local network. Communicating the first content from the first storage device to the second storage device may include communicating the first content from an end user device in a first local area network to an intermediate storage device in the first local area network. Communicating the first content from the first storage device to the second storage device may include communicating the first content from an end user device to an intermediate device through a local network using dormant local network capacity. Communicating the first content from the first storage device to the second storage device may include communicating the first content from an end ser device to a plurality of intermediate storage devices through a local network. Communicating the first content from the first storage device to the second storage device may include communicating the first content from an end user device in a first local area network to a plurality of intermediate storage devices in a second local area network. Communicating the first content from the first storage device to the second storage device may include communicating the first content from an end user device in a first local area network to a plurality of intermediate storage devices in the first local area network. Communicating the first content from the first storage device to the second storage device may include communicating the first content from an end user device to a plurality of intermediate storage devices through a local network using dormant local network capacity. Implementations of the described techniques may include hardware, a method or process, or computer software on a computer-accessible medium.

One general aspect a system includes a first storage device receiving and storing a first content. The system also includes a second storage device, said second storage device downstream from the first storage device. The system also includes said first storage device communicating the first content to a second storage device through a local area network. The system also includes the second storage device storing the first content. The system also includes a first user device requesting the first content; and said second storage device communicating the first user device when requested by the first user device. Other embodiments of this aspect include corresponding computer systems, apparatus, and computer programs recorded on one or more computer storage devices, each configured to perform the actions of the methods.

Further areas of applicability will become apparent from the description provided herein. The description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a high-level block diagrammatic view of a first example of a communication system.

FIG. 2 is a block diagrammatic view of a more detailed communication system of FIG. 1.

FIG. 3 is a block diagrammatic view of a plurality of user devices in a local area network.

FIG. 4 is a block diagrammatic view of multiple routers connected in a mesh network.

FIG. 5 is a diagrammatic view of plurality of user devices intercommunicating relative to a network and the radio coverage therein.

FIG. 6 is a detailed view of the interconnections of various local area networks and the interconnection of the devices therein.

FIG. 7A is a block diagrammatic view of the content distribution system.

FIG. 7B is a block diagrammatic view of the spectral efficiency module.

FIG. 8 is a flowchart of a method for determining the spectral efficiency and throughput for a system.

FIG. 9 is a block diagrammatic view of an intermediate or user device.

FIG. 10 is a block diagrammatic view of the operation for determining dormant capacity.

FIG. 11 is a high level flowchart of a method for operating a distribution system.

FIG. 12 is a high level flowchart of a method for operating the distribution system.

FIG. 13 is a block diagrammatic view of a system for local pre-positioning content from a storage device onto another storage device.

FIG. 14 is a signal diagram of the operation of the system of FIG. 13.

FIG. 15 is a flowchart of a method for operating the system of FIG. 13.

FIG. 16 is a block diagrammatic view of a local crowd-source content consumption system.

FIG. 17 is a signal diagram of the method of operating the system of FIG. 16.

FIG. 18 is a detailed flowchart of a method for operating the system of FIG. 16.

FIG. 19 is a block diagrammatic view of a pre-positioning system from an end user device to end user devices in another local area network.

FIG. 20 is a signal diagram for operating the system of FIG. 19.

FIG. 21 is a flowchart of a detailed method for operating the system of FIG. 19.

FIG. 22 is a flowchart of a method for discovering content at user devices.

FIG. 23 is a flowchart of a method for using user devices as a proxy to communicate signals therethrough.

### DETAILED DESCRIPTION

The following description is merely exemplary in nature and is not intended to limit the present disclosure, application, or uses. For purposes of clarity, the same reference numbers will be used in the drawings to identify similar elements. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical OR. It should be understood that steps within a method may be executed in different order without altering the principles of the present disclosure. The teachings of the present disclosure may be implemented in a system for electronically communicating content to an end user or user device. Both the data source and the user device may be formed using a general computing device having a memory or other data storage for incoming and outgoing data. The memory may comprise but is not limited to a hard drive, FLASH, RAM, PROM, EEPROM, ROM phase-change memory or other discrete memory components.

Each general purpose computing device may be implemented electronically in analog circuitry, digital circuitry or combinations thereof. Further, the computing device may include a microprocessor or microcontroller that is programmed to perform instructions (instruction signals) to carry out the steps performed by the various system components. A content or service provider is also described. A content or service provider is a provider of data to the end user. The service provider, for example, may provide data corresponding to the content such as metadata as well as the actual content in a data stream or signal. The content distribution system, service provider and end user devices may include a general purpose computing device, communication components, network interfaces and other associated circuitry to allow communication with various other devices in the system.

Further, while the following disclosure is made with respect to the delivery of video (e.g., television (TV), movies, music videos, etc.), it should be understood that the systems and methods disclosed herein could also be used for delivery of any media data and content type, for example, audio, music, data files, web pages, advertising, software, software updates, IoT data, weather, application, application data, “best of web” content, e-delivery of materials, etc. Additionally, throughout this disclosure reference is made to data, content, information, programs, movie trailers, movies, advertising, assets, video data, etc., however, it will be readily apparent to persons of ordinary skill in the art that the terms are substantially equivalent in reference to the example systems and/or methods disclosed herein.

While the following disclosure is made with specific broadcast services and network systems, it should be understood that many other delivery systems are readily applicable to disclosed systems and methods. Such systems include wireless terrestrial distribution systems, wired or cable distribution systems, cable television distribution systems, Ultra High Frequency (UHF)/Very High Frequency (VHF) radio frequency systems or other terrestrial broadcast systems (e.g., Multi-channel Multi-point distribution system (MMDS), Local Multi-point distribution system (LMDS), etc.), Internet-based distribution systems, or mobile distribution systems, power-line broadcast systems, any point-to-point and/or multicast Internet Protocol (IP) delivery network, and fiber optic networks. Further, the different functions collectively allocated among a service provider, user devices and intermediate devices as described below may be reallocated as desired without departing from the intended scope of the present disclosure.

User devices and intermediate devices may be coupled to the Internet through a constrained network or not even coupled to the Internet at all. In a constrained network, the speed or available resources may not be sufficient to provide a quality level of service. In the present examples, dormant capacity of the constrained network or a second less constrained network may be used to pre-position content at an intermediate device or a user device. The pre-positioned content may then be provided from the intermediate device storage directly or through a second communication network (i.e., local network) when demanded at the user device for real-time consumption, without having to rely on using the constrained network for that real-time consumption. The intermediate device may be located between the cellular network or other communication network and the user devices. In certain instances, the word “user” is used interchangeably with a device associated with a user (a user device) since each user has a user device associated therewith. The intermediate devices may also be referred a user device. That is, functions of the intermediate device such as storage for later content consumption may be incorporated into the user device. As will be described below the user devices and the intermediate devices may store content therein and may communicate content therefrom. When receiving the content from the content distribution system, devices may be referred to as a source device because the device will become the source for communication of the content for other devices referred to as target devices.

Wide area network dormant capacity is a resource or a plurality of resources that are not being used for transmitting data or content by a content system provider during regular customer use. Capacity may refer to the amount of bandwidth or spectrum available. Regular use of a communication network for primary customers may be referred to as a primary use. Dormant capacity may be referred to as a secondary use and may be governed between agreements between a content provider and a communication system provider. The content provider may wish to provide a service to users using the dormant capacity. Users may not be aware of the path the content traverses. The use of resources for the dormant capacity has a lower priority that may be allocated to another for a higher priority use. In the simplest sense, dormant capacity is a data path or bandwidth that is increasingly left unutilized during non-peak times of network use. Inversely, there is limited dormant capacity available during the peak times of network use. In all cases, such peak time of network use is characterized as the time when most of the usage of the services offered by the network is taking place by the network's users or direct customers. The non-peak time is the time when the least usage of the services is taking place by their users. For example, in a long-term evolution wireless network (LTE) system, which a wide area network, dormant capacity may be the bandwidth not being used for voice or data content requested from users in real-time. In the cases of “spectrum re-use,” capacity used by some users for real-time consumption of some content during peak times, may leave dormant capacity at the same time as capacity that is either unusable by other users for real-time consumption of other content or only usable by other users for real-time consumption of the same content, if that content is broadcasted instead of unicasted. In the case of “network re-use,” capacity used by some users for real-time consumption of content may leave dormant capacity that is not demanded by other users. In a satellite system, the dormant capacity is the bandwidth not being used for broadcasting of content to users for the sake of real-time consumption of such content or for voice or data content requested from users in real-time and may similarly be under-utilized as in wireless network systems. There is a very limited incremental cost for utilizing this dormant capacity, or the unused or under-used resources of a communication provider's network, as that cost is already being borne for the provision of regular customer use services, and as such offers means for highly cost-effective content distribution. By utilizing the dormant capacity that would otherwise be wasted, the present system allows communication system providers to use it to offer other services to customers or to sell the capacity to others.

Local area network dormant capacity (dormant local capacity) is a resource that is not being used for transmitting data or content through the local area network during regular customer use. The local area network may include a plurality of end user devices and intermediate devices that receive content through the capacity of the system. Capacity may refer to the amount of bandwidth or spectrum available for dormant use. Dormant local capacity may also refer to a band or separate radio resource not user by the local area network users or any capacity accessible to the device. Regular use of the local area network for primary customer devices may be referred to as a primary use, while unused capacity may be referred to as secondary use.

The dormant capacity may be used in various ways by intercommunication of the intermediate devices, storage devices (which may be part of the intermediate devices or the end user devices), the end user devices, the communication system provider, and the content service provider. In the cases of “spectrum re-use”, there have been many efforts to generate additional parallel uses of the same spectrum for real-time consumption by multiple users, using the same spectrum. However, utilizing dormant capacity, an almost infinitely high (as far as the number of users benefitting) amount of re-use may be generated by simply broadcasting this content, instead of unicasting it, and by having some users use it for real-time consumption, and for the dormant capacity to be used for non-real-time consumption by storing this same content at other intermediate storage devices at this same time, and then accessed by other users during a different time in the future, directly or using other communication networks, which may also be less constrained than the network described herein. Further, in the cases of “network re-use”, today this dormant capacity goes largely unutilized as operators have had a challenging time of incentivizing “changes in user behavior” to use the network more during “off-peak” times than they otherwise would like for real-time consumption—the benefit to consumers of using the network during peak times for real-time consumption instead of during off-peak times, far outweigh any incentives or benefits which the operators may pass on to the consumers to shift their real-time consumption. However, such dormant capacity may be used in-full for non-real-time consumption, by unicasting or broadcasting content using dormant capacity and by storing this content at other intermediate storage devices, and then accessed by other users during a different time in the future, directly or using other communication networks, which may be less constrained than the network described herein.

Queries as to the current availability of capacity and the upcoming availability of capacity, including real-time consumptions and the remaining capacity, may be formed in order to identify the availability of dormant capacity. Further, Quality of service (QoS) prioritization using evolved multimedia broadcast and multicast services (eMBMS) quality class identifiers, as well as quality-of-service class identifiers (QCIs) used in any wireless or other communication system, may be performed, providing higher QCI levels to traffic for real-time consumption, while leaving traffic for non-real-time consumption on lower QCI levels, effectively rendering it to use of dormant capacity only.

Prioritization of content to be communicated using the dormant capacity may be formed. Delivery of content using dormant capacity may be queue-driven. All of the content to be delivered may be placed into the queue with attributed priority levels for each portion of content, and then served from the queue automatically upon dormant capacity availability, coordinating which content is served in which sequence per what rule. Content may also be retransmitted using dormant capacity. User preferences (queuing), missing content (error correction), content most popular for some users (personalization), likelihood of consumption, content most popular for most users (popularity or short-tail optimization), as well as the remainder of content may all be used in prioritizing within queues.

The present system provides a high-capacity broadcast delivery system or a targeted unicast delivery system for pre-positioning content, that combines the strategic use of excess capacity or dormant capacity in a content communication network with pre-positioning content close to the users by caching and storage of such content at local content stores, to allow users to access a large amount of content such as over-the-top (OTT) content, software updates, or other highly intensive data applications without needing to traverse the content communication network at the time the content is desired. This system may use the wide area network dormant capacity and wide area dormant capacity of a system over the same exact spectrum (in the case of spectrum re-use) as real-time consumption by broadcasting content to users including to those requesting it for real-time consumption and to others using the dormant spectrum capacity for pre-positioning, instead of just unicasting it to only the users requesting it for real-time consumption, or over dormant capacity left-over from non-peak-use of networks for real-time consumption, by unicasting or broadcasting content for pre-positioning. As will be further described below, the system may use dormant capacity of different types of communication systems including but not limited to mobile or cellular systems such as an LTE system, a satellite system or a digital television system. Content such as video content may be provided to an intermediate device, which stores the content therein. When users request content for real-time consumption, the content may be provided from the stored or cached content store, rather than requiring that content to be served by the content communication network in response to users' requests and subjecting users to slow speeds of the constrained content communication network or from further burdening the content communication network. A wide variety of video programming including movies, television, shows, documentaries and news may be provided based upon user preferences. Also, other types of video programming such as instant replays may also be provided to users. The system may also be used to provide software and application updates for various types of users that are coupled to the intermediate device. The system may also be used for defense purposes or purposes in which high amounts of data are required, but whereas such data may be pre-positioned at the local content store by the content communication network and not be required to be delivered from the source of such data on a live or real-time basis.

The system is particularly suitable for rural customers, customers in markets with lower speed, lower capacity networks, or customers of companies that want to utilize their lower speed networks to offer an equivalent of high-speed cable or fiber network offerings, to have access to large data, over-the-top services or other large data applications. Specifically, the system may also allow non-rural or other customers to use wireless, satellite, TV, or DSL or other wired networks to effectively meet their content demands, without the need for an additional high-speed cable or fiber network offering. Thus, large data content, including over-the-top content (OTT) video, software updates, and other large data, may be offloaded to be served by the present system while the lower speed content communication network serves users' real-time/live voice and data requests, that cannot be pre-positioned effectively, using peak or regular capacity, and thus the need for high-speed cable or fiber network offerings within the home may be eliminated so that expenses may be reduced. The system may also allow congestion on even high-speed cable and fiber networks, or any of the aforementioned networks, to be alleviated by combining content delivery through pre-positioning using the dormant capacity and subsequent use from local content stores and by serving users' real-time/live voice and data requests, that cannot be pre-positioned effectively, using peak or regular capacity, in a unified system. Further, this system may also increase the effective capacity of broadband networks by using a much greater portion, or the entirety, of a content communication network's capacity, by using the combination of dormant capacity for pre-positioning of content and subsequent use from local content stores, and peak or regular capacity for serving users' real-time/live voice and data requests. If content that is likely to be consumed by the user is pre-positioned at the local content store, or the intermediate device, and then served from the intermediate device, the need to instead use the content communication network on a real-time/live request basis is reduced, especially in peak hours. Pre-positioning of large data, including over-the-top video and software updates, frees the capacity of mobile and fixed broadband networks for other real-time content requests, real-time two-way communications, or other live content consumption, especially during peak times. By combining a pre-positioning, dormant capacity approach with a real-time voice and data request, peak or regular capacity approaches, lower speed broadband service providers may compete head-to-head with established cable or fiber providers while any of the aforementioned networks improve their performance such as net spectral efficiency) by leveraging such a combination of approaches.

It is also desired for a system to be able to serve users requests from a first user for real-time consumption, using broadcast transmissions, not only when there are other users desiring the same content for real-time consumption (like in the case of the mode described in eMBMS), but also when there are other users who may desire this content for non-real-time consumption, in order to store this same content as in the first user's request in intermediate storage and then to access this content for real-time consumption but in the future, at a later time. When a first user requests to access content, instead of serving that first user's request using a unicast transmission, the system may instead serve that first user's request using a broadcast transmission, allowing that first user and any other user, desiring to access that content for real-time consumption, to real-time consume that content; while at the same time, the dormant broadcast transmissions to be able to be received by devices of any and all other users addressable by the broadcast transmission for non-real-time consumption, to store such content in those devices and for such any and all other users to access such content directly from their devices for real-time consumption at some later time.

The system could further make determinations of when it is advantageous to serve a given first user's request using a unicast transmission, as unicast transmissions are today higher throughput and have higher spectral efficiencies than broadcast transmissions on the order of 50-1,000%, and when it is advantageous to instead serve such first user's request using a broadcast transmission, where even though a broadcast transmission may be 50-1,000% disadvantaged in throughput and spectral efficiency than a unicast transmission, there are more than 50-1,000% more users than the first user which would benefit from having this request be received and stored by their devices for non-real-time consumption, and accessed for real-time consumption at a future time. This could involve analysis of not just how many users may benefit, but the likelihood of how many users may benefit based on analysis of their usage preferences, the likelihood of consumption, the popularity of the content in the request, and the likelihood that the cost of serving those users using unicast transmissions at a future time will be greater than the cost of using a broadcast transmission vs a unicast transmission at the current time.

Further, such system could also include a mechanism for determining whether any given device should receive the dormant capacity broadcast and store the data for non-real-time consumption, or if it should simply let it pass by. This determination could be based on its current available storage, the content already stored on that device for non-real-time consumption, and the content scheduled to be delivered to that device for non-real-time consumption, and the relative value of such opportunistic broadcast data and the cost of receiving it and storing it versus the value of the content already stored on that device or scheduled to be delivered to that device for non-real-time consumption.

For example, a first user desires to watch a movie #1, which is a relatively popular film, and requests it to be delivered for real-time consumption. The system analyzes that only 10% of the users in the same area as the first user, have movie #1 already stored on their devices for non-real-time consumption, but that of the remaining 90% of the users, 70% of those 90% or 63% would have a high likelihood of consuming movie #1 at a future time if it was stored on their devices for non-real-time consumption. The system serves movie #1 to the first user using a broadcast transmission instead of a unicast transmission, while having the other 63% of the users in the area as the first user receive the dormant broadcast transmission and store movie #1 for non-real-time consumption by the 63% of the users. In the future, some of the users whose devices stored movie #1 for non-real-time consumption, request to watch movie #1 at some future times, and movie #1 is served to them directly from their devices instead of using the network.

In the URL example, optimized usage of a multiplicity of resource types (storage, computing, networking), based on cost, performance and demand requirements is set forth. Traditionally, systems have looked at these resource types individually and one-dimensionally. For example, radio resource management focuses on optimal usage of RF resources based on service requirements, contentions between competing requirements and user Service Level Agreements (SLAs). Another individual resource typically considered is the management of fixed network resources, e.g., Software Defined Network (SDN) style approaches. Storage and compute management and cloud-based architectures have been considered individually.

In the present example a cohesive, a combinatorial use of such a diverse set of resources to facilitate cost-effective, performance-optimized delivery of content, based on user needs and demand patterns is provided.

While existing systems look to leverage in-network compute, storage and networking resources in a traditional cloud framework, this disclosure extends the concept to a “System as a Cloud” model—wherein resources (compute, storage and networking) may be interchangeably assigned and arbitraged across the entire system, including but not limited to the traditional cloud—processing and storage farms in the network core, wireless core network components and gateways, network edge nodes—such as base stations, access points/routers, small cells, cable edge boxes (e.g. CMTS), and the like, intermediate storage/caching devices, in the network or in the home or office, end user devices, e.g. smartphones, tablets, personal computers, and the like. This may include using the available storage of mobile devices as intermediate devices for non-real-time consumption, by applications of those mobile devices. This may also include using the available storage of the mobile devices for non-real-time consumption, by applications of other mobile devices completely separate from the first mobile devices. The present example determines, at any given time, the optimal combination of resources, across the entire system, to deliver content based on cost, performance (net spectral efficiency) and user demand considerations.

In the present system, wireless networking is used to enable orchestrated content distribution over a fabric of unicast and broadcast transmissions though one or more communication networks. A cohesive group of mechanisms is designed to enable optimal real-time and non-real-time content delivery, leveraging a continuum of broadcast and unicast delivery schemes in a coordinated manner, over any type of network available to the service provider. The system views any content transmission as a potential unicast or broadcast transmission and makes continual decisions on choice of transmission mode. The dynamic blending of unicast and broadcast deliveries creates a “breathing” apparatus, where the decision to broadcast or unicast a transmission is continually evaluated in view of various user device conditions and network conditions. Blending refers to determining the transmission modes of communication through which various devices receive content. The blend may be established as using all broadcast as the mode, all unicast as the mode or some devices using broadcast mode and some devices using unicast mode. Various conditions in the blend determination may be taken into consideration. The conditions include but are not limited to user device conditions and network conditions such as user behavior, actual consumption and likelihood of consumption or a content popularity metric, spectral efficiency of each transmission choice, available capacity in all accessible networks, network loading levels and the criticality of fulfilling real-time versus pre-positioned requirements.

The content distribution system or distribution system leverages the right mix of devices using unicast mode and broadcast mode transmissions through the wireless network to cover communicating content to the user devices efficiently relative to the network loading (with optimal use of radio resources), while delivering an optimal quality of user experience.

The delivery set forth herein is performed for a variety of delivery and consumption scenarios. For example, content delivery may be performed for live streaming. Live streaming is when multiple users view (consume) the live stream in real-time (at the same time). Some devices may also receive the live stream as part of content pre-positioning or caching for future real-time consumption from the cached location. Real-time content delivery, e.g., audio and video streaming, with an opportunistic broadcast. Real-time consumption by one user, with content pre-positioning or caching for future real-time consumption for any of the rest of the users. One example is set forth in U.S. Pat. No. 1,115,705 and is entitled “Method and System for Providing Non-Real-Time Content Distribution Services,” the disclosure of which is incorporated by reference herein. Other use cases are for non-real-time consumption scenarios where content is pre-positioned or cached for future real-time consumption by users.

At the same time, the content distribution system 10 uses the most suitable network to deliver its content through, taking into account the capabilities of the networks it has access to, and the cost of delivering through each network. All of this is done “over-the-top”, i.e., at the content distribution layer, which works above the IP layer to manage and an initiate the content distribution process particularly in the local area network. In contrast to the more transport-layer schemes adopted by wireless networks, this approach enables the system to be cognizant of application/content level popularity, usage and delivery success characteristics. The distribution system is far more aware of aspects like the assets it is delivering, device consumption patterns with response to these assets, asset popularity levels, etc. than traditional broadcast functionalities that sit at the transport layer and are simply purveyors of this content.

By gathering performance (spectral efficiency) feedback or collecting radio metrics from devices, the distribution system is further able to adjust its decisions on delivery mode to be used (broadcast vs. unicast). For example, the broadcast mode may be enabled if the distribution system 10 determines there are sufficient participating devices experiencing radio conditions better than a radio quality threshold value (or simply threshold). Additional users may be pulled into the broadcast segment of an ongoing transmission if those devices exhibit radio conditions better than the radio quality threshold. In this manner, the system always selects the most spectrally efficient mode of delivery. One consideration in the selection of the most spectrally efficient mode is the consumption pattern. The consumption pattern may include how many user devices need something now, how many user devices are predicted to need the content in the future, and how much cache do they have to store the content.

Another performance consideration is spectral efficiency. A comparative spectral efficiency of delivering content via unicast or broadcast is performed. Further, a comparative spectral efficiency of delivering content using different blends of unicast and broadcast may also be performed using different proportions of available capacity for broadcast and unicast and accommodating different sizes of user groups for broadcast and unicast. Lastly, the relative “rigidity” of unicast vs. broadcast in precluding support of real-time traffic in a sufficiently dynamic manner. Further details are provided below.

The present disclosure takes the distribution of content to a lower lever in the network to increase access to devices that would normally not be able to receive the content or allow the content to be distributed more efficiently or both. The system enables an intermediate storage device, that has been pre-positioned with content by a content distribution system (referred to from hereon as distribution system), to distribute the content to other devices (storage devices and end-user devices) that are in the vicinity of the source storage device and have connectivity to the source storage device via local networking means. Essentially, a crowd source distribution system is set forth.

In a baseline scenario of a storage device (referred to a “source storage device” in this example) has been pre-positioned with content by a distribution system. This invention enables the source storage device to perform various tasks that are briefly summarized below.

For example, the source storage device may pre-position (cache) content, stored on the source storage device, onto another storage device in the vicinity (a target storage device) without having to go through the wide-area wireless/broadband network. The target storage device may then serve the content to end-user devices to which it is connected.

The source storage device may also stream content to any end-user device to that has connectivity thereto, not just the end-user devices that are, for example, part of the home organization or zone that the source storage device is part of.

This concept may then be extended to end-user devices (e.g., mobile devices) as well. An end-user device may be used as a micro-storage device and may have content pre-positioned therein by the distribution system. The end-user device in this example may be referred to as a source end-user device that may pre-position content onto another device (a target storage device or target end-user device), which can, in turn, pre-position or serve the content to other devices connected to it. The source end user device may stream content to any end-user device that has connectivity to thereto., not just the end-user devices that are, for example, part of the home organization or zone that the source end-user device is part of.

In essence, the examples herein provide a crowd-sourced method for distributing content from a device to other devices that are “visible”. This is all done over local networks (e.g., Wi-Fi) without having to traverse the wider-area (e.g., cellular wireless or satellite or cable) network.

A mesh network of intercommunicating access points or routers may be employed to reduce the system reliance on the wide area network. The meshing effect creates a multiplicative, crowd-sourced effect. The larger the density of devices that can “see” each other, the wider the distributive capability of this local network. What this means is that for every device that has been pre-positioned with content via the wider-area network, multiple additional devices are able to receive the same content via local means, offloading the wider-area network in each case. Implying that every instance of use of the wide-area network's dormant capacity to make a delivery to one storage device gets “leveraged” to make deliveries to a multiplicity of other devices without using the wide-area network's dormant capacity. An indirect way of “broadcasting” content using one delivery stream via the wide-area network to multiple devices may be provided effectively using a “broadcast without broadcasting” scheme.

Crowd-sourcing provides capacity relief to the wide-area network. In other words, less 4G or 5G network dormant capacity has to be used to deliver a quantum of content to a given number of devices. This eases the dormant capacity demand on the wireless network.

This scheme also provides coverage (range) extension benefits. Devices that are in radio-disadvantaged conditions relative to the wider-area (e.g., cellular) network can connect to other nearby devices (with strong wide-area network coverage) and obtain content from those devices. Hence, this local distribution scheme effectively extends coverage to devices that might otherwise not connect effectively to the cellular network.

The denser the local conglomeration of devices is, the higher the crowd-sourced distribution opportunities will be, and the greater the need for local distribution, as well.

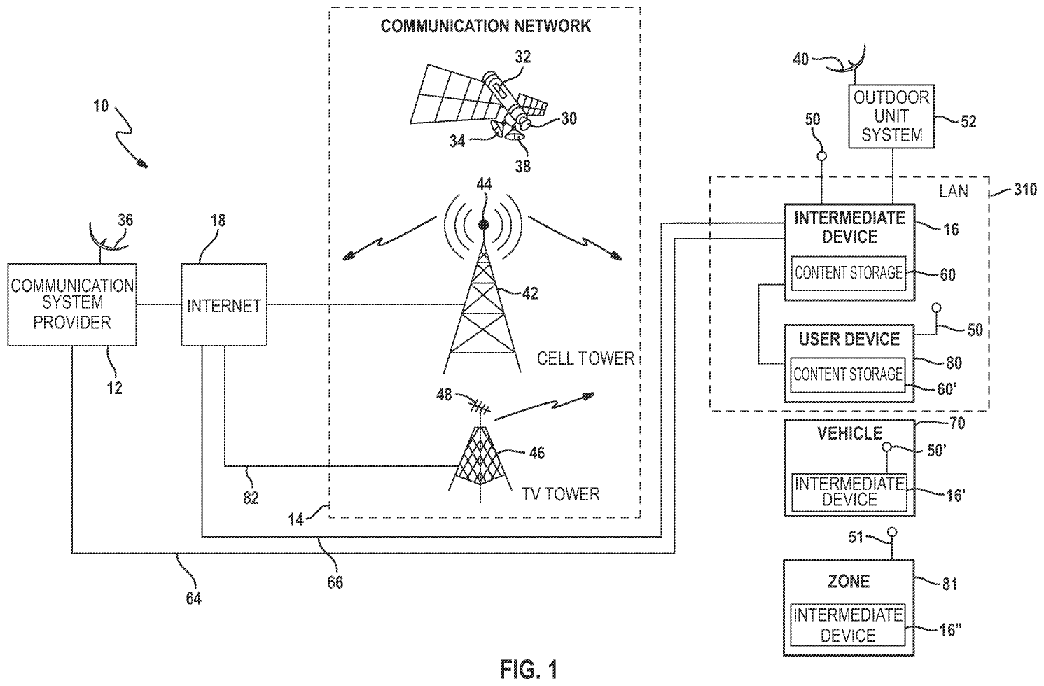

Referring now to FIG. 1, a high-level block diagrammatic view of a content distribution system 10 is set forth. In this example, a communication system provider 12 is a system that is in communication with a wide-area communication network 14 and controls the operation of the communication network 14. The communication network 14 is in communication with one or more storage devices such as an intermediate device 16. The communication network 14 may be in direct connection with the communication system provider 12 or to the internet 18. The communication system provider 12 controls the schedule and placement of content through the communication network 14. The communication system provider 12 may receive content from various sources as will be described further below.

The communication network 14 is in communication with the internet 18. The communication network 14 may be a single stand-alone network or may be a combination of different networks or even different types of networks. That is, the network capacity of one or more networks may be combined deliver content to the intermediate device 16 or user device 80. The communication network 14 may be wireless. The communication network 14 for communicating content to the intermediate device 16 or user device 80 may include a satellite 30 that has one or more transponders 32 therein for receiving and communicating content therefrom. The satellite 30 may also include a receiving antenna 34 that is in communication with an antenna 36 of the communication system provider. A transmitting antenna 38 communicates content to an antenna 40 of the intermediate device 16 or user device 80. The antennas 34, 36, 38 may represent multiple antennas or multiple types of antennas. The satellite components may be referred to as a satellite network.

The communication network 14 may also include a cell tower 42, or any other wireless transmission device, having an antenna 44 (or antennas) thereon. The antenna 44 may represent a cellular antenna, a Wi-Fi antenna, or any other wireless transmission antenna of the cell tower 42 and may communicate content wirelessly to the intermediate device 16 through the antenna 44, from the communication system provider 12, including also wirelessly through the antenna 44.

The communication network 14 may also include a television network comprising a television tower 46 having an antenna 48 thereon. The TV tower 46 may communicate content to the intermediate device 16 or user device 80 from the communication system provider 12.

The communication network 14 may communicate using real-time capacity, dormant capacity, or a combination of both as will be further described below. The dormant capacity may include various types of resources that are not being used for serving users' real-time/live voice and data requests and their real-time/live voice and data consumption, and that are more ideally used for pre-positioning of content to the intermediate device 16 or user device 80. As mentioned above, the communication network 14 may effectively distribute (pre-position) content on real-time or a non-real-time basis to the intermediate device 16 or user device 80, for subsequent consumption by users directly from the intermediate device 16 or user device 80 instead of from the communication network 14. The communication network 14 may use a combination of broadcasting, multicasting and unicasting for communicating content for real-time use.

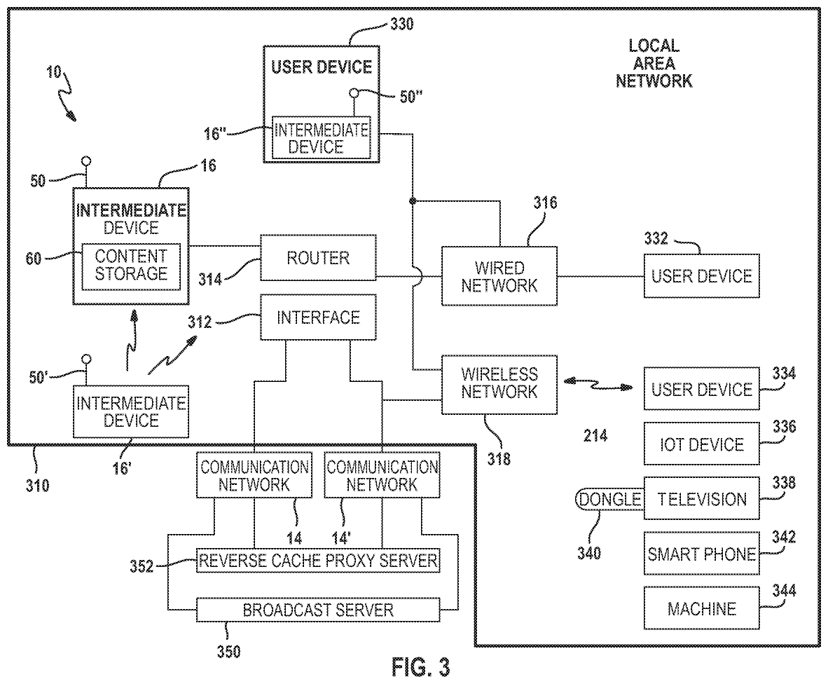

As shown in more detail in FIG. 3, the communication network 14 may communicate to a local area network 310, which would in turn communicate the content to the intermediate device 16 or user device 80, or the intermediate device 16 or user device 80 directly, using various types of access systems so that a maximum amount of content may be provided to the various intermediate devices. or the user device 80. The local network may be but not limited to Wi-Fi, Bluetooth®, coax such as multi-media over coax (MoCA), Ethernet, cable, etc. The communication network 14 may use frequency division multiple access, time division multiple access, spatial division multiple access, code division multiple access and orthogonal frequency division multiple access. Depending upon the requirements of the system and the types of systems provided, different types of access protocols may be used. As mentioned above, functions of the intermediate device may be included in a user device and therefore the intermediate device 16 may be referred to as a user device or a storage device.

The intermediate device 16 or user device 80 may also have an antenna 50 disposed thereon. The antenna 50 may communicate with the antenna 44 and the antenna 48 of the communication network 14. By making the intermediate device 16 portable, the antenna 50 may be placed in a position of high reception. The intermediate device 16 may act as a small cell.

An antenna 40 of an outdoor unit system 52 may be used to communicate with the antenna 38 of the satellite 30. The antenna 40 may be a flat faced phased-array antenna. Details of the outdoor unit system 52 and the intermediate device 16 are provided below.

The intermediate device 16 may also include a content storage 60. The content storage 60 may include a solid-state content storage (memory), a hard disk drive or a combination of both. The content storage 60 may be designed to hold a substantive amount of data on the order of multiple terabytes or greater. The content storage 60 is used to store pre-positioned content received through either the antenna 40 or the antenna 50. The intermediate device 16 may also be in communication with a back haul network 64. The back haul network 64 may be part of the communication network, which, as demonstrated, is presented as wireless systems. The back haul network 64 may be a wireless network as well. Content storage 60′ may also be incorporated into the user device 80.

The system 10 may be suitable for both pre-positioning content and distributing in real-time live or stored content using a wired network 66 as well. That is, the intermediate device 16 or user device 80 may also be coupled to the Internet 18 through the wired network 66. Content may be pre-positioned using the dormant capacity of the wired network 66 as will be described below. The wired networks may be a DSL network, a cable network, or a fiber network.

The communication network 14 may also be in communication with a mobile device such as a vehicle 70. The vehicle 70 may include an intermediate device 16′ configured in the same manner as that of the intermediate device 16. The vehicle 70 may include various types of vehicles including an automobile, a ship, a bus, a train, an airplane or the like. The intermediate device 16′ is coupled to one or more antennas 50′ that may be located on the exterior of the vehicle. Of course, the antennas 50′ may be located within the vehicle 70 at the intermediate device 16′.

The user device 80 may be in communication with the intermediate device 16. For convenience, a line representing either a wireless or wired connection is presented between the user device 80 and the intermediate device 16. The user device 80 requests content from the intermediate device 16 and, more particularly, from the content storage 60 of the intermediate device 16.

A zone 81 such as a stadium, office building, hotel or multiple dwelling units may have an intermediate device 16″ with an exterior antenna 51 in communication with the satellite antenna 38, the antenna of the cell tower 42 and/or the antenna 48 of the TV tower. The zone 81 may represents the association of devices in a local area network in which the intermediate device 16″ is disposed. The intermediate device 16″ may represent a storage device that is in communication with other end user devices and other storage devices within the zone 81. When a local area network is within a zone, the local area network may extend some distance from the building boundaries. The distance may vary depending on various physical limitations of the wireless router, building materials and the like. The zone 81 may also have a plurality of routers or access points linked together. This is particularly true for large facilities.

The cell tower 42 may use LTE technology or other cellular technology. In particular, the cell tower 42 may use LTE-B technology to communicate with the intermediate device 16 or user device 80. A wired connection 82 may be disposed between the communication network 14 and the internet 18 and/or communication system provider 12. As will be described below, the intermediate device 16 may be part of the cell tower 42 and thus the antenna 44 may act as a Wi-Fi or WiMAX antenna for communicating with the user devices.

The connection between the communication network 14 and the internet 18 or the communication system provider 12 may also include dormant capacity. This dormant capacity may be utilized by the system in a similar way as the afore described dormant capacity, to distribute pre-positioned content to the communication network 14 or to the internet 18, for their in-turn distribution of the pre-positioned content, including using dormant capacity, to ultimately reach the intermediate device 16.

More than one of the systems and devices illustrated in FIG. 1 may be incorporated into a system. In fact, more than one system or device is likely whereby it encompasses a broad geographic area.

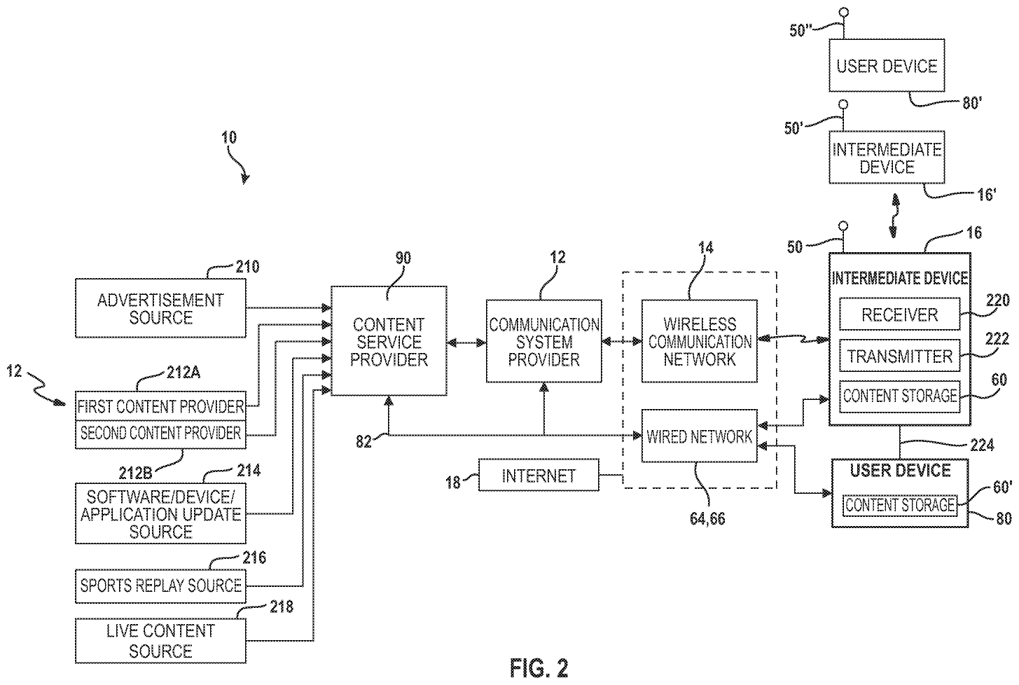

Referring now to FIG. 2, further details of the content distribution system are shown. The communication system provider 12 may be more than one entity. The communication system 12 provider is shown in the first content provider 212A, the second content provider 212B communication with a content service provider 90. The content service provider 90 is a system that is used for providing content to the communication system provider 12. The content service provider 90 and the communication system provider 12 may be business entities. The content service provider 90 may purchase the dormant capacity of the communication system provider 12. The content service provider 90 may be a service provider that is subscribed to by the users of the user device 80. However, the content service provider 90 may include pre-existing services such as mobile phone service providers, cable providers, digital television providers and the like. The content service provider 90 communicates various instructions to the communication system provider 12 so that the content is distributed in a desirable way. In one example, stored content is communicated with bit rate data or metadata corresponding to the speed the content is recorded or to be played out so that the desired communication speed for real-time consumption is provided. By the communication system provider 12. Details of the intercommunication between the systems are described in further detail below.

The content service provider 90 may receive content from various sources including an advertisement source 210, the first content provider 212A, the second content provider 212B, a software/device/application update source 214, a sport replay source 216 and a live content source. The advertisement source 210 may communicate advertisements to the content service provider 90. The advertisements may include video, audio and metadata associated therewith. The metadata associated with an advertisement may include desired targets for which users would find the content desirable. Metadata may also include and a product definition.

The content providers 212A and 212B may also provide video and audio content as well as metadata for the content. The metadata may include the content title, actors or actresses, and various other identifying data including various categories such as genres and the like. The content may be requested from the content providers or indicated to be pre-positioned at the intermediate devices by the content providers.

The software/device/application update source 214 may provide new software, software updates, device updates and application updates to the intermediate device 16 through the content service provider 90 and the communication system provider 12, intended for the user device. The updates may be incremental changes to software resident in a user device, whereas the new software may be software not currently within the user device or intermediate device 16. The software and updates may be requested by a device for non-real-time delivery or delivered through no action of the device and pre-positioned at the intermediate device based on the identity of the user device, the software or the applications residing thereon.

The sports replay source 216 may provide sports replays to the content service provider 90 for distribution to the intermediate device 16. The sports replay content may be short video clips of certain special or important events of a game or match. Sports replays may be clips that include both audio and video content. The sports replay may also include metadata that identifies the team, the players involved, the sport, the clip or replay display title and the like. The clip display title is what may be displayed to a user in a user interface.

A live content source 218 may also be included with in the system 10. The live content source 218 may provide live or real-time content that is broadcasted by the system. Real-time or live content may also be unicasted. The live content is communicated in a live content stream and has various characteristics including a playout bit rate. The live content stream may be played back or viewed in real-time at various user devices or intermediate devices. As will be described below, other devices may receive a unicast of the live content as well. Preferably, the content or stream may be communicated with at least the bit rate at playout. Details of a mix of broadcast and unicast for communicating content is described in detail below.

The content providers 212A, 212B, the sports replay source 216 and the live content source may also provide data or instructions to communicate certain content to specified devices. Metadata included with the various types of content described above allows the content to be distributed to the proper intermediate device, intermediate devices or user device 80 on the right schedule while accommodating any other content distribution priorities while using the dormant capacity of the communication network under the control of the communication system provider 12.

The intermediate device 16 is illustrated having content storage 60 and also a receiver 220. The receiver 220 may be used to receive communications from the wireless communication network 14. A transmitter 222 may be used to transmit wirelessly or by wire to and from the wireless communication network 14, the wired network 64 and/or the wired network 66.

The user device 80 is illustrated having a direct or wired connection 224 with the intermediate device 16 or a direct or wired connection with the networks 14, 64,66. The intermediate device 16 may thus be a dongle or other type of directly connected device to the user device 80. The wired connection 224 may be an HDMI or USB connection.

More than one intermediate device may be disposed in a system. The intermediate device 16 may also communicate with a second intermediate device 16′. The intermediate device 16′ may be configured in the same manner as that of the intermediate device 16. The intermediate device 16 may communicate from the antenna 50 to the antenna 50′ of the intermediate device 16′. The intermediate devices 16, 16′ may form a peer-to-peer network or a portion of a mesh network, which is described in more detail below. Of course, more than two intermediate devices may form a peer-to-peer or mesh network. The peer-to-peer network may communicate various types of content therebetween. That is, if one intermediate device misses a portion of a content transmitted from the wireless communication network 14, another intermediate device may be queried to determine whether the intermediate device includes the missing content. The missing content may thus be communicated in a peer-to-peer basis between the antennas 50 and 50′. The wireless communication network 14 may also distribute various portions of the content that are then communicated to various other intermediate devices in an intentional way rather than a “missing” way. If content is desired by the user of one intermediate device but is not available at that intermediate device, the intermediate device for the intentional request may request the content from another intermediate device within the peer-to-peer network. Further, some such intermediate devices 16′ may be configured to not have an ability to receive content from wireless communication network 14, and only be able to communicate with other intermediate devices 16 and 16′ to receive such “intentional” or “missing” content.

The intermediate device 16′ may be in communication with a user device 80′. The user device 80′ may be in communication with the intermediate device 16′ through the antenna 50″. The user device 80′ may be configured in a similar manner to that set forth at the user device 80′ but may be a wireless device rather than a wired connection as is illustrated with respect to the user device 80.

Referring now to FIG. 3, the communication system provider 12 may be in communication with a local area network 310 through the communication networks 14, 14′ as described above. Only the communication networks 14 and 14′ are illustrated for simplicity even though more may be a part of a system. FIGS. 1 and 2 do not illustrate the local area network 310. The local area network 310 may have an interface 312 for communicating with the communication networks 14, 14′. The interface 312 may be a modem.

The local area network 310 may also be coupled to the second communication network 14′. The second network 14′ may be the primary two-way connection to the Internet for the user devices 332-344. The second network 14′ may represent dial-up or a digital subscriber line. As described in the examples set forth herein, the system 10 may be used to pre-position content in the intermediate device 16 or a user device 332-344. The supplementation of content is particularly useful when the second communication network 14′ for providing regular internet service to the user devices 332-344 is slower than the speed of the communication network 14, although not necessarily. It is possible that the local area network 310 may not have a two-way connection to the internet except the pre-positioned content received through the communication system.

The local area network 310 may also include a router 314. The router 314 may be used for connecting the intermediate devices with user devices within the local area network 310. The use of the router 314 may be referred to as an indirect connection because to the communication through the router 314. The local area network may provide both a wired network 316 and a wireless network 318. Various devices may take advantage of each method of communicating. As mentioned above a number of routers 314 may be associated with a local area network.

The router 314 may be in communication with one or more intermediate devices 16, 16′ as described above. The local area network 310 may also include an intermediate device 16, along with an interface 312. The intermediate devices 16, 16′ includes the content storage 60 and the antenna 50 as described in FIGS. 1 and 2. The intermediate device 16′ is in communication with the local area network 310 and may exchange content or other signals with the intermediate device 16 through the local area network 310. An intermediate device 16″ may also be located within a user device 330. The user device 330 or the intermediate device 16″ therein may include an antenna 50″ for communicating with the local area network 310. The intermediate device 16″ may receive content using the dormant capacity of the communication network 14. The user device 330 may be one of a variety of types of devices including a video game console, a cellular phone, a set top box or the like.

The user device 330 may be coupled to the local area network 310 through either the wired network 316 or the wireless network 318. The user device 330 may also communicate directly with other user devices and intermediate device directly using Bluetooth®, near-field communication (NFC), Zigbee® or other short range communication device.

A user device 332 may be coupled to the local area network 310 through a wired network 316. The user device 334 may be coupled to the local area network 310 through a wireless network 318. As mentioned above, the user devices 332, 334 may be various types of user devices including a cellular phone or smartphone, a tablet, a laptop, a TV or the like. The user device may be referred to later collectively as the user device 80.

An internet of things (IoT) device 336 is a type of user device that may also be coupled to the local area network 310 through the wireless or wired networks 316, 318. The IoT devices 336 may require software and application updates suitably delivered via dormant capacity.

A television 338 is a type of user device that also may be coupled to the local area network 310 through the wired network 316 or the wireless network 318. The television 338 may be a smart television for directly coupling to the wired network 316 or the wireless network 318. However, the television 338 may also require a dongle 340 that is used for communication with the wireless network 318. The dongle 340 may have an application therein for providing the television 338 with a graphical user interface. The dongle 340 may also include a content storage for storing content therein. The dongle 340 may also act as an intermediate device for receiving and storing content.

A smartphone 342 is a type of user device that also may be in communication with the wired network 316 and the wireless network 318 so that access to the local area network 310 may be obtained.

A machine 344 is a type of user device that also may be in communication with the local area network 310 through the wired network 316 or the wireless network 318.

All of the user devices 330-344 may be in communication with the wireless network 318 using many different types of standards including Bluetooth and Wi-Fi. Each of the user devices 330-344 may receive content through the local area network 310 directly or from at least one of the intermediate devices 16, 16′ and 16″. The application for retrieving and serving content to the user devices 330-344 may be in the devices 330-344, in the intermediate device 16, in the local area network 310, in the router 314 or in the interface 312. The user devices 330-344 may also have content storage incorporated therein. The integral storage may allow the user device to act as an intermediate device.

The types of content may include audio content, video content, operating system updates, other software updates, applications, weather information, “best of web” content and e-delivery of various materials. The users of the user devices 330-344 may each obtain the various types of content from the content storage 60 of the intermediate device 16. The content may be obtained individually or simultaneously from the content storage 60. As will be described below, the user devices 330-344 may provide an inventory list or a list of desired content that is communicated through the local area network 310 and ultimately back to the communication system provider 12 of content service provider 90 illustrated in FIGS. 1 and 2. The communication back may be performed with either the communication network 14 or 14′.

A broadcast server 350 may be coupled to the communication networks 14, 14′. The broadcast server 350 may be used for broadcasting content to various user devices 80 and intermediate devices 16. The broadcast server 350 may broadcast content that is stored or provided by a content provider or source. The broadcast server 350 may also communicate content in real-time that is live. The broadcast server 350 is a network component that manages broadcast sessions across a multiplicity of networks. The distribution system may identify to the broadcast server the preferred network to be used for the broadcast with an identifier signal having a network identifier.

A reverse cache proxy server 352 is also in communication with the communication networks 14, 14′. The reverse cache proxy server 352 is described in further detail below. The reverse cache proxy server 352 caches content for efficient delivery to proximal users. The reverse cache proxy server 352 may be within or next to the wireless network, or elsewhere in the broader network.

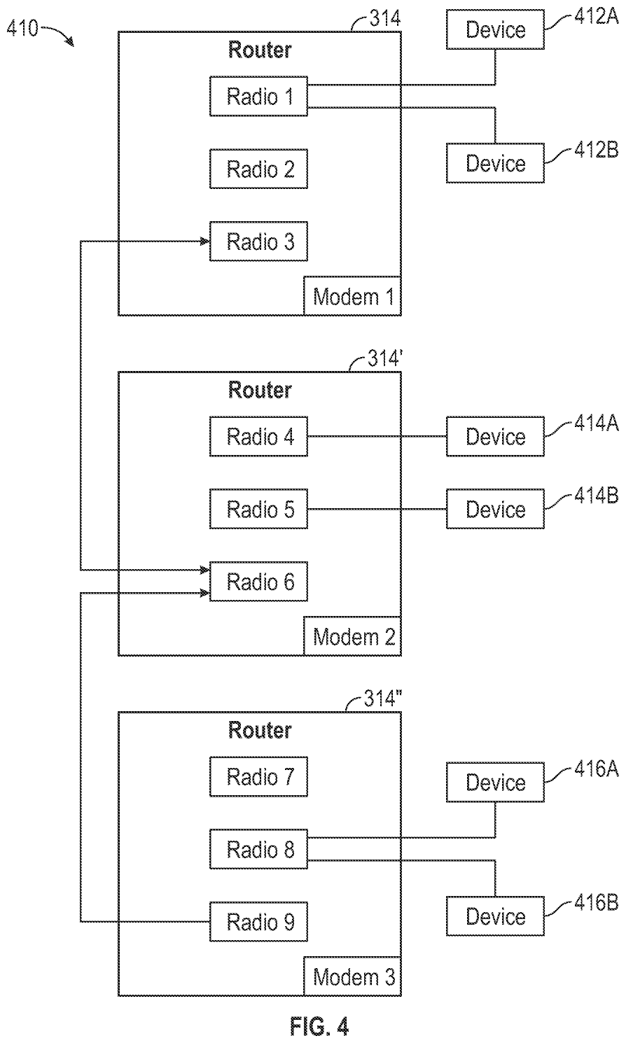

Referring now to FIG. 4, a plurality of routers 314, 314′ and 314″ form an example of a mesh network 14. The router 314, in this example, has radio 1, radio 2 and radio 3. Router 314′ has radio 4, radio 5 and radio 6. Router 314″ has radio 7, radio 8, and radio 9. Each router 314, 314′ and 314″ has a respective modem: modem 1, modem 2 and modem 3. The mesh network 410 may be formed using intercommunication with anyone of the radios of one router with the radio or radios of another router. However, in this example, radio 3, radio 6 and radio 9 may be dedicated to the mesh network 410. Radio 3, radio 6 and radio 9 may be a hidden radio with a hidden service set identifier (SSID) disposed within each router 314, 314′ and 314″. By providing the hidden SSID, the intercommunication between the radios 3, 6, 9 may be unencumbered by other traffic within the various routers 314, 314′ and 314″. Each of the routers 314, 314′ and 314″ form a local area network therearound. The distance that the radio signals travel may incorporate adjacent routers so that the other routers may intercommunicate. In this example, router 314 may generate radio signals strong enough to communicate with at least one of the radios 4, 5, 6 of router 314. The reverse is also true about router 314′ and 314. In this example, router 314′ may generate signals strong enough to communicate with both router 314 and 314″. Router 314 and 314 and 314″ may not be in direct communication. However, using the radios disposed within the routers, radio 3 of router 314 may communicate with router 314′ and radio 6 disposed therein. In this manner, the devices 412A and 412B may communicate with devices 414A and 414B in different local area networks. The devices 412A and 412B may communicate content to the devices 414A and 414B and vice versa. Likewise, the presence of content, content information and content location may all be intercommunicated from the devices 412A, 412B and devices 414A and 414B. Of course, each of the devices 412A and 412B may intercommunicate through the router 314. Likewise, devices 414A and 414B may intercommunicate through the router 314′. In addition, router 314″ has devices 416A and 416B associated therewith. The devices 416A and 416B may also intercommunicate through the router 314″. In this example, the devices 416A and 416B may intercommunicate with the devices 414A and 414B of the router 314′ and vice versa. The devices 416A and 416B may also communicate indirectly with the devices 412A and 412B associated with the router 314. The radio 9 may communicate signals from the devices 416A and 416B to radio 6 which, in turn, communicates the signals to radio 3 of the router 314. As mentioned above, the signals may include the presence of content, content information, the content itself or location signals.

The devices 412A, 412B, 414A, 414B, 416A and 416B may represent a user device and an intermediate device both of which may be referred to as a storage device.

Of course, three series connected routers are illustrated in FIG. 4. However, many routers may be interconnected to each of the routers to form the mesh network 410.

The routers may also act to intercommunicate in a particular zone. The routers 314, 314′ and 314″ may be incorporated into a multi-dwelling unit, an enterprise or a home so that extended coverage may be provided wirelessly. The mesh network 410 may therefore be disposed within a home. However, the routers 314, 314′ and 314″ may also be spaced out in different multi-dwelling units, different enterprises, different dwelling places and the like. For interconnection, one router may be within the range of another router.

The radios, radio 1, radio 2 and radio 3, may be independent radios that intercommunicate within the routers themselves. The radios may have different frequencies, such as 2.4 GHz, 5.0 GHz and the like. Of course, other frequencies may be used. The radio 3 may be a separate radio resource such as a separate radio, as mentioned above, dedicated to communicating within the mesh network 410.

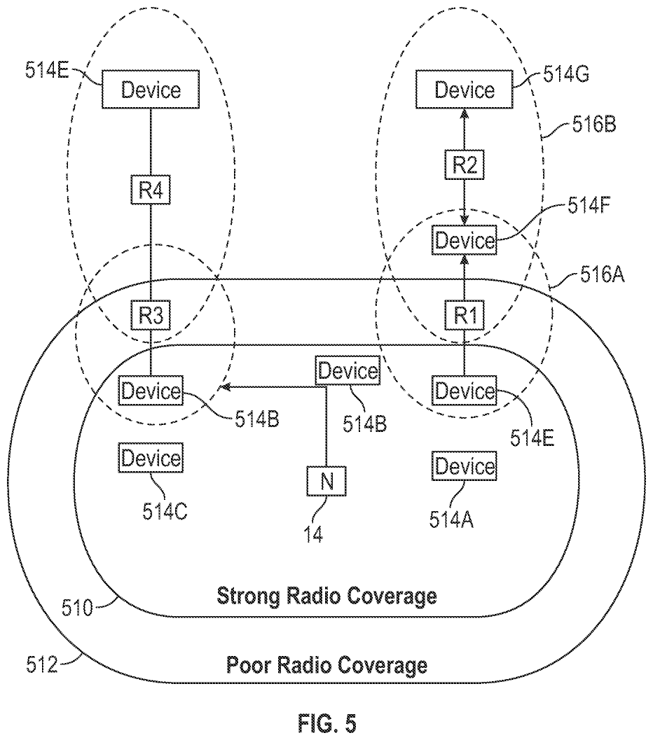

Referring now to FIG. 5, the wireless network 14 is illustrated. The wireless network 14 has a signal strength limit that defines strong radio coverage boundary 510. That is, a distance from the network 14 to the strong radio coverage boundary 510 allows the devices therein to communicate effectively with the network 14. A poor radio coverage boundary 512 defines the limit for communicating with various devices from the network 14. Between the strong radio coverage boundary 510 and the poor radio coverage boundary 512, a poor radio coverage exists representing possible communications with a device. Outside of the poor radio coverage boundary 512, no coverage may exist.

Devices 514A, 514B, 514C and 514D are all within the strong radio coverage boundary 510. Thus, the devices 514A-514D may communicate effectively with the network 14. It should be noted that any of the user devices 514 set forth herein may refer to an intermediate device, an end user device, both of which may be referred to as storage device.

The relative position of a first local area network 516A and a second local area network 516B are illustrated. The user device 514E is within strong radio coverage and communicates with the router R1. Router R1 is within the poor radio coverage region and therefore may or may not communicate with the network 14. However, the device 514E may be in communication with the network 14. This allows the device 514E, which may be an intermediate device, to receive and store content or content data which may be communicated to the device 514F through the router R1. The content may be unicasted or broadcasted to the device 514E. The device 514F may be within both the first local area network 516A and the second wireless area network 516B. The device 514F may therefore receive the content that is stored within the device 514E but also communicates with devices within the local area network 516B such as the router R2 and the device 514G. In this manner, any content provided to the device 514E may be communicated to the device 514G which is outside of the strong radio coverage boundary 510.

Device 514D may be located within the strong radio coverage boundary 510. The device 514D may be in communication with the router R3 wirelessly or wired which, in turn, is coupled, wirelessly or wired, to the router R4. This allows the content or content data received at the device 514D to be communicated from the device 514D through the router R3 and the router R4 to the device 514E. Device data and content may likewise be transferred from the device 514E to the device 514D through routers R4 and R3. In this matter, the content location of content within the device 514D may be known by the device 514E as well as the content and the location of content within the device 514E may be known by the device 514D.

This device-device local distribution mechanism set forth above may iterate down multiple levels. A storage device that has received content from another storage device can, in turn, percolate the content to another “underlying” storage or end user device, and so on. In a dense deployment, content may proliferate to a multiplicity of devices, without having to use the wide-area network 14 to reach these devices. The denser the local conglomeration of devices is, the higher the crowd-sourced distribution opportunities will be. And the greater the need for local distribution, as well.

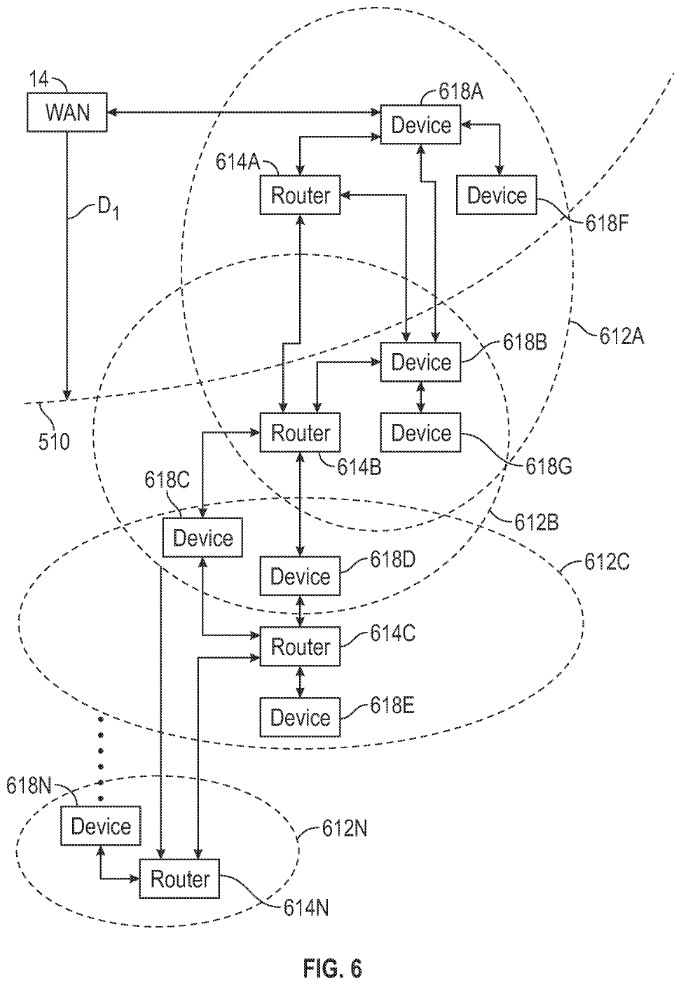

Referring now to FIG. 6, the operation of the intercommunication of various local area networks relative to a wide area network 14 is illustrated. In this example, the poor radio coverage boundary 512 is illustrated a predetermined distance Di away from the network 14. In this example, three overlapping wireless area networks 612A, 612B and 612C are illustrated. Routers 614A, 614B and 614C are illustrated at the center of the respective local area networks 612A, 612B and 612C. The router 614A is in communication with the device 618A, 618B, 618F, and 618G. The router 614A is in communication with the router 614B. The router 614B is in communication with the device 618B, the device 618C, the device 618D and 618G. The router 614C is in communication with the device 618C, device 618D and 618E. In this example, the router R1 is in the strong radio coverage boundary 510 and therefore may receive signals from the wide area network 14. Likewise, the device 618A and device 614F may also receive communications directly from the network 14 via unicast or broadcast. Any content communicated to the device 618A may be communicated to the other devices within the network because router 614B communicates with router 614A which allows the router 614B to communicate with the device 618B, 618C, 618D and 618G. Either device 618C and 618D may communicate with router 614C and thus the device 618E. Device 618F is in communicating with device 618A directly or through the router 614A. Device 618G may be in communication with the device 618G directly or through the router 614A. Any content disposed in any of the devices 618A-618G may therefore be communicated to the other devices. It should be noted that devices 618C and 618D may intercommunicate directly using various short range technologies, such as Bluetooth®, Zigbee®, Near-Field Communication (NFC) or the like. However, should device 618C or 618D want to communicate with device 618E, the router 614C acts as an intermediatory. As long as one device, such as device 618A, is within the strong radio coverage boundary 510, other devices outside the strong radio coverage boundary 610 may obtain any content received at the device 618A.

In one example, device 618A receives content from the wide area network 14. The device 618A is a storage device such as an intermediate device. The device 618A may communicate signals to the device 618B and the device 618F. The devices 618B and 618F are downstream devices relative to the device 618A and may each be an intermediate device, a storage device or an end user device. Downstream means further away from the origin or the content distribution system. For example, the local area network is downstream of the content distribution system. A storage device is downstream of the content distribution system but may be upstream of the end user devices. The device 618B may communicate with another downstream device 618G, which may be an intermediate device, a storage device or an end user device. The device 618G may generate a request for the content from the device 618B. The device 618B communicates the content to the device 618G in response to the request. Communication of content within the local area network may take place using dormant local network capacity as described below.

Each of the local area networks 612A-612C represent a level of devices. In theory, the number of devices and routers may extend infinitely through communication from device to device or device through a router to another device. A network 612N has a router 614N and at least one device 618N that represent a level at least one level below the level represented by network 612C.

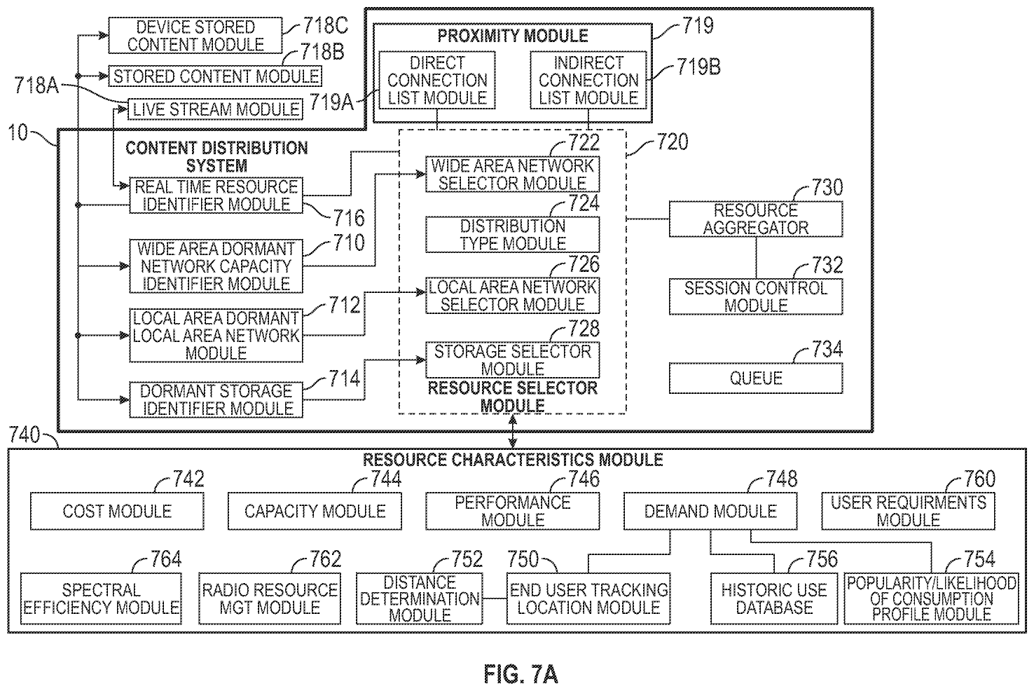

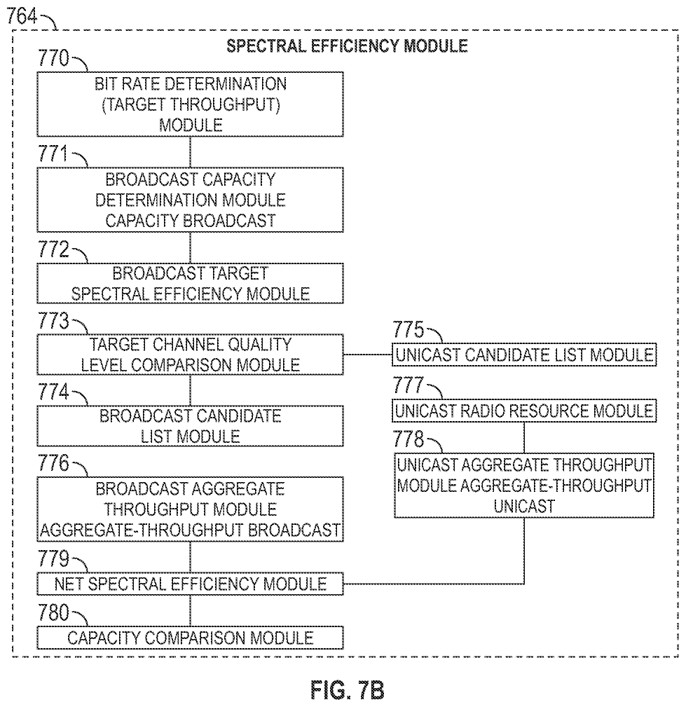

Referring now also to FIG. 7A, the content distribution system 10 or controller thereof is illustrated in further detail. The controller of the content distribution system 10, which could be a based largely in the cloud, may play a significant role in facilitating the local content distribution. In the following description the controller and the content distribution system are used interchangeably.

The content distribution system 10 determines a combination of system resources for communicating content and storing the content therein. In the following example the content distribution system coordinates the movement a storage of content thought the communication system. In other examples, such as within local area network. The content distribution system 10 may coordinate users in direct communication and indirect communication. In another aspect, the content distribution system 10 also determines the communication resources to communicate the content from storage to the end user devices using wide area dormant capacity and local area dormant capacity. In this example, the system 10 includes a wide area dormant resource identifier module 710, a local area dormant capacity module 712 and a dormant storage identifier module 714. The content distribution system 10 may generate probe signals at the content distribution system 10 to obtain the wide area and local area network resources that are dormant, and the amount of storage that is dormant within the communication system. Each of the modules 710-714 may generate a probe signal. However, one probe signal may be sent for determining all the dormant resources within the network as provided in this example.

A real-time resource identifier module 716 is also incorporated into the content distribution system 10. In the present example, the real-time resource identifier module 716 is coupled to a live stream module 717 and a stored content module 717B. The live stream module 718 is used for communicating live stream content to the user devices for real-time consumption. That is, the live stream module 718A identifies the content that is to be communicated using real-time resources identified by the real-time resource identifier module 716. Based upon various considerations as mentioned above and will be described in detail below, the content may be communicated in real-time using various network resources (both wide area network and local area network) and types of distributions such as unicast or broadcast. In addition, the live stream module 718A together with the real-time resource identifier module 716 may allow devices that do not consume the live stream content in real-time to store the content. Various intermediate devices may store the content for later consumption by the intermediate device or transmission to the user devices within a local or unconstrained network or other user devices.

The stored content module 718B is in communication with the real-time resource identifier module 716 and the dormant network resource identifier module 710, dormant compute identifier module 712 and the dormant storage identifier module 714. The stored content identified by the stored content module 718B may be communicated in real-time using regular network resources or dormant network resources.

A device stored content module 718C may also be in communication with the content distribution system 10. In the device stored content module 718C, the content distribution system 10 may be cognizant of which content assets are stored in which devices. For example, the content distribution system 10 will be aware of content assets that have been pre-positioned on any storage device, intermediate device or end user device within its distribution network. Therefore, when content needs to be pre-positioned locally from one device to another, the content distribution system 10 may determine from which device to pre-position the content. In particular, the device stored content module 718C may store the location of content stored within various user devices within various zones of the content distribution system. That is, the device stored content module 718C may store a device identifier and the location such as a network identifier in which the device is located. The device stored content module 718C may include content within the storage devices such as the intermediate devices and end user devices.

A proximity module 719 of the content distribution system 10 is aware of which devices a given target device has radio proximity to for forming a connection for receiving content. The proximity module 719 determines the devices with a direct connection and an indirect connection. Based on the two factors: (a) which devices a given target device may “see” radio-wise; and (b) which of those devices has (have) the required content, the content distribution system 10 may determine the source device for the pre-positioning transfer. For example, if the target device may “see” multiple devices that have the content, the content distribution system 10 may select the device with best radio connectivity to the target device.

A direct connection list module 719A is disposed within the proximity module of the content distribution system 10. The direct connection list module 719A has a list of the devices such as the user devices and the intermediate devices and the local area networks to which they are directly connected.

An indirect connection list module 719B provides a list of the indirect network connections for the devices within the local area networks. For example, end user devices and intermediate devices may be associated with a local area network as mentioned above relative to the list module 719A. However, the user devices and intermediate devices may also be indirectly connected to adjacent networks through the routers, or the like as mentioned above. The routers of adjacent networks may be in communication with each other so that content may be communicated between various intermediate devices and user devices of adjacent local area networks. The intercommunication of local area networks may form a mesh through which content stored within one local area network may be communicated to devices within other local area networks linked together through the mesh network.

A resource selector module 720 is used for selecting the resources for storing the content or communicating the stored content to end user devices or intermediate devices through wide area networks and local area networks. The resource selector module 720 includes a wide area network selector module 722 for communicating with the wide area network or networks through which the content is communicated in route to the content storage or from the content storage to an end user device.

The resource selector module 720 may also include a distribution type module 724. The distribution type module 724 may select the distribution type for the network. For example, the distribution type module 724 may select broadcast or unicast based upon various characteristics described below.

A local area selector module 726 is used for selecting the local area network or networks used for communicating the content to the content storage or communicating the content from the content storage to the end user devices. As will be described in more detail below, content may be communicated to a device within a local area network as selected by the local area network selector module 726. Further when content is to be communicated from a device within a local area network to another deice within the local area network or a device outside the local area network the local area network selector module 726 may allow the target device to receive content from a source storage device.

The resource selector module 720 may also include a storage selector module 727. The storage selector module 720 selects the device for storing the content. The storage selector module 727 also selects the storage from which to communicate the content to the target device such as an end user device or another intermediate device. The determination of the resources may be determined for a particular time in the network whether it is for content storage or for distribution to one or more end users.

The content distribution system 10 includes a resource aggregator 730. The resource aggregator 730 selects the wide area network(s), the local area network(s) and the storage resources (intermediate devices, end user devices) for communicating content thereto or communicating the content from the storage device to a target device such as an end user device.

The content distribution system 10 then communicates the resource decision to at least the target device, telling the target device to download the content from the identified source device and providing the target device precise asset location details, such as a file name/ URL.

This source device selection may also be done more autonomously by the concerned devices. The decision may be made between source and target devices in a self-organized manner by exchanging content information. In many scenarios, however, a more centralized approach, coordinated by the content distribution system 10, may be more efficient.

A queue 734 may also be disposed within the content distribution system 10. The content distribution system uses the queue content prior to distributing content to the various resources such as the intermediate device or devices and the end user device or devices. The queue 734 stores the content to await the availability of dormant capacity when communicating the content through the wide area network.

A resource characteristic module 740 is used for determining the resources to be used and a timing therefor. The resource characteristic module 740 may provide a cost for providing the resource at the cost module 742. The cost module 742 may determine a dollar cost or an opportunity cost for providing content. Although a cost module 742 is illustrated within the content distribution system 10, each of the resources, such as the local area or wide area network(s) and storage, may provide cost data of costs to the content distribution system 10.

A capacity module 744 is used to determine the capacity of the network (spectrum) associated with the communication system and the capacity of the storage that is available throughout the network. The capacity module 744 may determine the total capacity of the system, e.g., the total spectral capacity of the wireless system. The dormant capacity may also be determined. As well, the capacity module 744 may determine or help determine how much capacity could be dedicated to broadcasting, multicasting or unicasting (in various iterations described below). In a 4G or 5G system, the capacity may be measured by the physical resource blocks (PRBs) that are available for broadcast or unicast or a combination thereof.

A performance module 746 determines the performance of the resources of the system. For example, the performance module 746 may determine the transmission speed or throughput of a network, the speed at which the compute may store the content, and the speed that the content storage may store the content. The performance module 746 may obtain radio conditions such as throughput or network speed at a device from feedback signals from the devices themselves. Multiple devices may provide radio condition signals to the content distribution system 10 in order to obtain a broader view of the network conditions. Ultimately the conditions determined at the performance module 746 are used to determine the spectral efficiency and ultimately the net spectral efficiency or the maximum net spectral efficiency when spectral efficiencies are compared.

A demand module 748 may determine actual demand and predict a future demand for a particular content or related content. The output of the demand module 748 may be in a user demand number. For example, a first number of user devices are demanding live content and a second number of user devices may actually request the content in the future (not in real-time). A consumption pattern for content may be determined based on various factors. The demand module 748 may be associated with or determine demand from a wish list for each of the devices within the network. The demand module 748 may also determine demand from a push list. provided by a content provider. A content provider may determine that certain user enjoy certain content. Devices may have content pushed to them in response to the push list. The push list may take into consideration past use, geographic area (location) and other considerations. The home location of the user may correspond to certain content such as sporting events. However, while travelling, other content relevant to the current location of the user device may be provided to a user. The demand module 748 may also be associated with an end user tracking and location module 750. The end user tracking location module 750 may track the mobile end user devices and the stationary end user devices to determine the amount of demand within a geographic area.

A distance determination module 752 may determine a distance to the end user or the content storage system. The distance determination module 752 may also determine the distance from the content storage to an end user or a source content storage device to a target content storage device. By knowing the demand at the demand module 748, the geographic area of the demand (geographic demand) and the potential movement of the end user devices, content may be strategically located and communicated. An example where this may be useful is in a particular neighborhood with a particular ethnicity or sports team affiliation. A content genre may be relevant more to certain geographic areas (geographic popularity). For example, a high school football game may be relevant to people within a limited number of square miles nearby a certain school. The location of the user may therefore be used to change the number of users. This is especially true in a system that is geographically distributed, and portions are served by different resources. The demand predictions for certain content may be for certain geographic areas.

A popularity/likelihood of consumption profile module 754 may also be communication with the demand module 748. The popularity/likelihood of consumption profile module 854 may determine a popularity and/or how likely it is for a user device to consume a particular content. The likelihood of consumption may be based on one or more of collaborative filtering, or demographics, use of content by others. The users may therefore have a consumption profile used in collaborative filtering to compare with the consumption profiles of other individual user devices or groups of user devices. Collaborative filtering takes into account interests or tastes of many users. Collaborative filtering may be to learning the level of popularity and demand. As well, a timing of the demand may be determined. A demand or popularity and timing of the demand or popularity from a first user device or a first group of user devices may be used to determine whether to pre-position content based on that level of demand or popularity and the timing of the demand or popularity to a second group of devices. This may include a determination as whether to choose broadcasting, multicasting or unicasting of the content. The learning of level of popularity and personalization for the second group may be performed through collaborative filtering of the second group against the first group requesting the content through post-positioning and then pre-positioning content to the second group based on the pre-positioning.

The level of timeliness for a given group may be learned through collaborative filtering as well. The rate of increase in popularity determined through hits or requests for the content may be monitored. As the hits increase, the timeliness increases. The content may therefore be propositioned base on the popularity and the timeliness.

The content priority is used to define a content priority schedule for the second group based on the determinations from the first group. Pre-positioning with the right priority level may be performed, whether by unicasting, by multicasting or by broadcasting. The higher priority content is positioned immediately of in the very near future from the determination. Lower priority content is pre-positioned in the future or not at all. As well, higher priority for the group may correspond to broadcasting for the group.

Content partners or other external source such as Nielsen may also provide a timeliness indicator and a level of popularity (a supplemental content priority) to augment what was learned from level of popularity determinations above and demand from end users. That is, the learned content priority and the supplemental priority may be used to determine what, when and where to pre-position content.

Likelihood of consumption may be determined by collaborative filtering including determining actual consumption of similar content to the content, a prequel to the content, or sign-ups for similar content to the content, actual consumption of the content and actual consumption of the similar content to the content, the prequel to the content, or the sign-ups for similar content to the content by other users. User data corresponding to the interests, tastes and demographics of a user may allow the system to determine that the user of the device is in a particular gender, in a particular age group, in a particular ethnicity, and in a particular income and may be interested in a content and therefore likely to consume the content. Use-based likelihood of consumption may predict likelihood of consumption when other users watch similar content. “Watching” content is a form of actual consumption This may be combined with other users watching (actually consuming) similar content and then watching (actually consuming) the content in question. That is, another user device having watched similar content as others may also watch the content in question because others have. Content may be divided into parts. Parts of a series (episodes, prequels, sequels and the like) or parts of the content divided into smaller segments, portions or chunks. Another indication of likelihood of consumption is the actual consumption of the first part of the content by other users. This may mean they may be likely to want to consume a second part. In addition, actual consumption of the second part of the content by other users may be used as part of the actual likelihood of consumption of further parts. As mentioned above the popularity of different parts of a content may be used in the pre-positioning decision. That is within the content itself the manifest may have URLs for different content portions with different bit rates. The likelihood of consumption of a content portion at a certain bit rate may be determined by the consumption of another segment at another bit rate. Not all bit rate versions of each segment may be pre-positioned. The likelihood of consumption of parts of the content may be used as an indication that other users are more likely to consume the content. The popularity of a content may be determined from audience measurement or from a predictor of popularity as determined by a human entity. Demand is similar to popularity but refers to the actual consumption rather than predicted or predetermined values. The popularity may be determined based on a number of users that have signed up for a content. For example, a number of users that have signed up to stream a real-time content or live-content. When live content becomes more popular, and potentially popular with other user devices not currently receiving the live stream based on collaborative filtering, the live content may be switched from several individual live streams to one live stream.

Popularity may also be determined based on past popularity of content that is similar. Similar content may be part of the same series of movies or programming, have the same genre, the same or similar actors and the like. Similar or the same genres may also be used to determine popularity for past popularity. Popularity could be determined from a wish list or wanted list as well. Users provide input on content they would like to view in the future in a wish list. Certain content may be inherently popular at certain times. For example, the providing of Olympic content during the Olympics may have an increased popularity. On Sundays in the United States, National Football League content may be more popular.

The popularity of content may also be determined in several ways with several different inputs. The popularity of the content may be determined by the network cache request rate. That is, the amount of times that the content is requested from any device from the network cache 442 may be determined. When the network cache request rate is greater than a network cache request rate threshold, the content may be determined as being popular. A geographic popularity using a geographic request rate may also be determined in the popularity/likelihood of consumption profile module 854. When user devices in a particular geographic area request the content from the network cache 442, the popularity is increased. Likewise, a request rate may also be determined of users with similar consumption preferences or profiles. That is, users that download or request similar content may be used as a prediction as to whether similar consumption may take place at another user device. Multiple access consumption requests may also be considered by the system as being popular. For example, various types of gaming and programs may be accessed multiple times by a user and thus the popularity may be high.

A past history change value of a content may also be considered when determining the popularity of content. For example, a past history of infrequent changes to the content may increase the popularity because the content itself rarely changes and therefore once content is stored within a cache, the content may not need to be updated very often. The past history change value may be compared to a past history change threshold. When the past history change value is below the past history change threshold, the content may be popular. Therefore, it makes sense for content distribution system 10 to store the content at a cache closer to the user devices.

As users desire content, content may be missing from the home cache and from a network cache. The popularity may be determined at the same time. Pre-positioning may be performed to accommodate live consumption by a second group of users. The popularity takes into consideration content communicated live as well. The popularity may be used to change how the content is distributed. Opportunistic broadcast may be performed as a combination of above. When enough users that have similar interests (collaborative filtering) are watching individual streams of the same live content, the system may switch the users to a broadcast.by monitoring the profiles of the groups of users and users likely to join in. That is, when the number of users are receiving individual live streams exceeds a broadcast threshold, the live stream may switch from individual streams (like unicast) to a broadcast stream for all devices. Further, the anticipated users may be included in the broadcast threshold comparison. For example, the individuals receiving the content stream and the anticipated number of users that may view the live stream determined through collaborative filtering may be compared to a broadcast threshold. When the threshold is exceeded, the content is broadcasted.

The popularity also applies to a correlation between segments of a first content, or between pieces of content for one user or across users. That is, when segments 1-5 of a content have a high popularity or a being demanded, other segments may be pre-positioned based on the popularity, demand and timing of the popularity. If a content or content segments are in demand, other related segments of content may be demanded and thus the popularity may be increased. In addition to the first content, pre-positioning other pieces of first content or a second (different) content or content segments may pre-positioned. Correlating across segments of content has two general cases. First determining from the popularity of parts of the first content that a user (and other users) are going to watch other parts of the same content. e.g., if a user has watched the first episode of Breaking Bad, that user is likely to watch other episodes and the rest of that episode. Likewise, certain other “correlated” users are likely to watch those episodes as well. In a second aspect, the popularity of the first content is used to determine a second content that a user and other users are likely to watch may be determined. For example, if a user has watched Shrek, he is likely to watch Finding Nemo and certain other “correlated” users are likely to watch Finding Nemo as well. Content segments or the entire content of a second content may be pre-positioned based on the first content.

A historical use database 756 may store user participation for various content, content genres and content related to a particular content. A genre is for content are similar forms, style or subject matter. Examples include but are not limited to action, romantic comedies, comedies, drama, thriller, horror, historical, western and adventure. Historical trends for certain content and genres of content may be used to predict future (non-real-time) user device consumption for particular content. For example, actual consumption of a prequel may indicate the popularity or likelihood of consumption of a certain content. As will be described below pre-positioning as well as real-time predicting may use data in the historical database to determine the mode such as broadcast or unicast for content or a live stream.

A user requirements module 760 may also be incorporated within the resource characteristic module 740. The user requirements module 760 may associate various user requirements with each end user or end user device. The user requirements module 760 may include the definition of the service to which the subscriber has subscribed. For example, some users may value rapid response in terms of updating or providing content. This may signal the content distribution system 10 to locate the content closer to the end user.

The resource characteristic module 740 may also have an efficiency module that is used for determining a consolidated efficiency metrics that is used for the determination of which combination of resources to use. The costs per byte per user may be determined.

A radio resource management module 762 may also be included in the resource characteristic module 740. The radio resource management module 762 may take into consideration a service resource agreement from various service sources and various service level agreements in order to determine whether to use a particular resource.

A spectral efficiency module 764 may be used to determine the efficiency of the spectrum used for each transmission choice. By determining the spectral efficiency of each transmission choice (a unicast spectral efficiency and a broadcast spectral efficiency), the appropriate transmission resources such as the network, the distribute type, the compute and the storage may be determined appropriately. The spectral efficiency and the capacity module 744 together with other data are used for making the selection of the appropriate resource at the resource selector module 720.

In summary, the content distribution system 10 determines, for any content to be distributed, the optimum combination of resources to leverage at a particular time. Real-time or live content distribution requires immediate resources that may be chosen as combinations of broadcast and unicast. Broadcasting may be used not only for real-time consumption but also for simultaneously populating storage devices in user devices or intermediate devices. In other considerations, if cost minimization is the prime consideration, positioning content as close to the user as possible (e.g., in an intermediate storage device in the home, office, or in the user's end device itself) might make the most sense. In this scenario, performance optimization is a natural by-product, since delivering the content from close to the device will maximize throughput and minimize latency and jitter effects.

On the other hand, if the piece of content has a high enough popularity level (i.e., a large number of users are likely to watch (actually consume) the content), it could make sense to locate the content a bit deeper in the system (e.g., in one of the access network nodes or even in the core cloud). In this case, even though the networking cost may be higher, it may be amortized across a larger number of paying users. The timing of the popularity may also be factored in. As well, the content may be segmented into content portions or chunks and the determination whether to pre-position is performed for various segments of the content.

It is therefore helpful to view the decision determination in terms of a consolidated efficiency metric that enables the content distribution system 10 to decide which combination of resources to use. An example of a metric is cost/bit/user—or some equivalent of this. The cost/bit component reflects the price and performance aspect of the delivery option and normalizes the cost incurred relative to the performance rendered. The “User” denominator then normalizes the metric further, to factor in demand/popularity, and the number of users interested in the content.

In terms of a distribution and delivery strategy, various principles may be followed. Such principles may include pre-positioning content, using dormant network capacity (or, at least, the least expensive network path(s)), at one or more sites, edge nodes, home access points, or end user devices—the idea being to move content as close to the interested user population as possible, using free or inexpensive resources.

Another determination in the distribution and delivery strategy is leveraging the dormant storage and computing where the dormant storage is available in the system. The best location or locations for pre-positioning is determined in view of the cost and performance of the ultimate delivery to the end user device.

Another determination is picking the best time to pre-position content while factoring in available dormant capacity and the ability of the storage device to efficiently receive data to be pre-positioned. The location may also be a consideration. That is, communicating when the device is in strong radio conditions may be important. The end user device may be exposed to varying conditions when mobile. An example of a determination could be: does the distribution system deliver live from the network at the time of consumption, vs. store now at Location A and deliver at consumption time from A, vs. store now at Location B and deliver at consumption time from B, vs. store now at Location C and deliver at consumption time from C, and so on. Basically a “least cost route” option is set forth that factors in how many users may be covered from each location or route.

Another determination is the best network path to leverage to pre-position content in the device. When the user is ready to consume the content, delivery is enabled with minimal cost involved, e.g., if the caching was done at storage local to the user, network costs at consumption time would be zero or minimal.

In the following, a few use cases are presented. The first case is wish list content. For wish list content that is part of a user's wish list (e.g., specific movies, episodes of a TV show etc.). The content distribution system 10 may determine that the optimal approach here is to pre-position this content to the user right away, after the user indicates that their desire for a particular content since the user does not need to immediately consume the content.

The content distribution system 10 may decide to pre-position or cache the content in, e.g., an intermediate storage device in the user's home, or in the end user device itself (if the user is known to regularly use a specific device to consume streaming content). The deeper in the content is positioned, the lower the eventual cost of delivery (e.g., delivery from local storage—no network costs involved) and the better the user's quality of experience.

When the content distribution system 10 determines that this content has a high enough popularity level, the content distribution system 10 may cache the content at a further upstream point in the network (relative to the end user devices), e.g., a base station, or a wireless network node. Upstream storage allows for the content to be available to a larger number of users. The content distribution system 10 may also decide to cache portions of the content bundle at different locations, e.g., position metadata, program information etc. locally on the end user device, and the core content further upstream. Such decisions may be performed at the resource aggregator 730.

In either case, the content distribution system 10 could make a decision to deliver content to any (or more than one) of the storage nodes mentioned earlier, based on the cost and performance tradeoff of such a delivery with the cost and performance of the storage and its compute. The likelihood of the storage being able to fulfill a real-time video serving request and the volume of users that would be addressable by the storage, may also be considered. For each potential content storage positioning location being considered, the content distribution system 10 considers the cost of storage, and (at the point of delivery to users) what the compute and network delivery costs would be. The popularity level and the timing of the popularity level (consequently how many users would have access to the content from each location) may also be factored in to a decision to deliver content or content segments using unicast delivery or broadcast delivery, since broadcast delivery is somewhat less efficient than unicast delivery to a single node, but much more efficient than unicast delivery when attempting to deliver something to multiple nodes simultaneously, since the delivery efficiency would be higher (and the cost would be effectively amortized) if a larger number of users may be serviced.

For example, if the cost of storage in the home is $1, the cost of real-time delivery is $10, and the cost of pre-positioning using dormant capacity is only $2, then the likelihood of video consumption (for example 50%) may be considered. The effective cost of real-time delivery compares to a $6 cost (($1+$2)/50%) of pre-positioning and subsequent serving given the likelihood of such an event. Now if this example is expanded, and the cost of pre-positioning using broadcast over dormant capacity is $6 (since less efficient for any 1 user), but 100 users may be addressed by the broadcast, and the likelihood of video consumption is 33% across the group of 100, then the effective cost of pre-positioning and subsequent serving given the likelihood of such an event drops to $3.18 (($1+$6/100)/33%). Finally, if the cost of storage in the home is entirely a sunk cost, and is shouldered by the user, the above costs or pre-positioning and subsequent serving drop further to $4 and $0.18, providing dramatic cost and performance (such as spectral efficiency) improvements.

For gaming applications, the content distribution system 10 may decide to pre-position or cache a gaming application requested by the user. In this case, the content distribution system 10 may place real-time-critical and bandwidth intensive components of the application such as but not limited to graphics data and intensive user interface and rendering components close to the user (e.g. in an intermediate storage device in the home, or in the user's commonly used gaming device(s)) and place the compute-intensive pieces further upstream, where a larger pool of compute and memory resources may be available. In this manner, the caching location may be used to store just a portion of the total content, application or web payload while the low-bandwidth portion of the payload may be served from the origin server, which may provide higher compute capacity.

Another use case is for pre-positioning software updates. A software service provider may need to do this from time to time. That is, software updates may be required for end user devices. Dormant network capacity may be used to pre-position a software update in a user device or in an intermediate storage device close to the user. The user may incorporate the updates at a subsequent time of their choosing.

In general, the decision to pre-position content may be driven by a user, or users, placing the content on their wish lists, or the content distribution system 10 proactively deciding to place the content in suitable locations based on the content's popularity profile relative to the population of user and specific personalized reference for any given use and hence, expected demand in the near future. In every case, the content distribution system 10 will need to select the combination of storage and compute resources in the system based on various factors including candidate storage locations having the requisite storage capacity. Another factor is the cost of storage. Another factor is whether dormant (unused) storage space available at that location and whether the dormant capacity may be leveraged free of charge, or at a lower cost.

With respect to the network when the user decides to consume the content, the network communications cost be at that point and for real-time consumption may be considered. The cost of pre-positioning distribution using dormant capacity and the dormant (unused) capacity available at that point in time may also be considered along with the relative cost of such distribution. The cost efficiency may also be considered for pre-positioning distribution using broadcasting, multicasting or unicasting. Another consideration is how many other users are likely to be interested in the content.

The end result of these determinations is that the content is cached at one or more locations in the system. Typically, an access network edge node (e.g., small cell, base station, access point) used as the caching location might provide more limited, and more expensive, compute and storage resources. However, the communication costs might be lower, and performance is likely to be better, compared to a more upstream location, because network backhaul costs and latencies are being cut out of the equation.

The related decision the content distribution system 10 must also select the mode of transport such as unicast or broadcast. If the pre-positioning location is in the network, a point-point (unicast) approach may be applied. If the decision is to locate the content in the user's end device or intermediate storage device in the home, the content distribution system 10 may decide to opportunistically push the content to multiple users (especially if the content's popularity profile is high) using a much more spectrally efficient broadcast approach when distributing the same data to multiple users at once.

When the user is ready to consume the content (i.e., requests delivery), the content distribution system 10 delivers from the most appropriate storage location. The content distribution system 10 will look at all points where the content is currently cached or is available (including the origin server in a cloud location) and determine the best location from which to deliver from based the communication system conditions at the time. The conditions include the network delivery cost from each candidate location and the current compute power available at the location, vs. the computing needs of the application. The content distribution system 10 then delivers the content using the best (possibly least expensive) network resources available that may handle the performance requirements. If delivery is from local storage, networking resources may not be needed.

The live streaming (consumption) case is a subset of the content delivery scenario described above. If the user is requesting content that has not been pre-positioned anywhere, the content distribution system 10 delivers content from the origin server in its cloud.

The radio resource management processing used by the distribution system 10 for a live broadcast has some differences from that used for pre-positioning of content for non-real-time consumption. The distribution system 10 performs a set of radio resource management determinations while contemplating the introduction of a broadcast session to carry the live stream. For live broadcasting (for real-time consumption), the target throughput is determined, and participating devices need to meet channel quality (radio conditions/metrics) requirements.

First of all, the distribution system 10 may pick a delivery bitrate for the broadcast. This is to at least equal the bitrate of the selected version of the audio/video to be live-streamed. The system will select a bitrate version of the multimedia content to be delivered—a high enough bitrate that delivers a high-quality user experience. The audio/video playout rate of the content on the device's client has to equal this recorded bit rate of the audio/video. Which means the delivery bitrate of the broadcast has to at least equal this recorded bitrate (buffering possibilities are limited in a live stream so the communications bitrate has to equal or exceed the playout or recorded bitrate).

The target throughput for the broadcast is at least equal the audio/video bitrate. This, in turn, determines the spectral efficiency level (i.e., modulation and coding scheme or MCS) to be used, given the spectral capacity (KHz of spectrum) available for use. The system, therefore, selects a target spectral efficiency level that enables the performance target (target throughput in this example) to be achieved. The spectral efficiency is the bits per second per frequency (bps/Hz) which in turn corresponds to a modulation and coding scheme. When the conditions are good, a high modulation may be used. Likewise, a higher coding scheme (fewer redundant bits) may be used. The spectral efficiency is related to the throughput such as the target throughput divided by the available capacity.

Spectral efficiency (bits/s/Hz)=Target Throughput/Available spectral capacity (Hz)

The available spectral capacity (spectrum) is determined by the content distribution system 12 or 10 based on the received capacity reports from the network. As mentioned above, the available capacity may be reduced by a margin to the target available capacity utilization goal. Capacity usage reported by the network could be expressed as % of total channel (e.g., cell) capacity; in which case, spectral capacity (Hz) may be derived by applying that percentage against total spectral capacity (Hz) available in the channel (or cell). The spectral efficiency level that is tolerable by the device (tolerable spectral efficiency) may be determined based on the radio channel metrics gathered from the device. The content distribution system 10 uses the radio channel quality of the device 16 (measured by signal strength, signal/noise-interference ratio (SINR), channel quality indicators, and other similar metrics) to determine a target modulation scheme and coding scheme (MCS) level for the device. The mapped MCS level reflects the highest modulation order to that the particular device in its current radio conditions, may reliably demodulate; as well as the level of channel coding (forward error correction) that needs to be applied to correct errors. The determined MCS level may be directly translated to a spectral efficiency data value, and the content distribution system 12 combines spectral efficiency with available capacity (as outlined earlier) to target throughput. Note the target throughput may be determined for each device individually based on the radio conditions at each of the particular devices. In the present system all of the determinations may be done in the cloud (by the content distribution system 12) which effectively integrates radio quality information with content distribution specifics as a cross-layer optimization.

This, in turn, implies that the devices participating in the broadcast must be experiencing radio conditions at least as good as required to receive delivery at this target spectral efficiency level. A device whose radio conditions are weaker than the radio condition (quality) threshold level will receive a degraded user experience or receive no content at all since the device will not be able to demodulate much of the signal being transmitted.

The distribution system 10 includes in a potential broadcast of this stream, from the pool of participating devices, only those that pass the radio quality threshold. The rest of the devices (the radio-disadvantaged devices) may stay on unicast.

Additionally, the distribution system 10 determines the most spectrally efficient transmission mode, i.e. the optimum combination of broadcast and unicast user group sizes, given the participating devices' radio conditions. The distribution system 10 evaluates overall spectral efficiency for each combination of broadcast and unicast user group sizes. As was described many iterations may be calculated before one is selected. This is described in detail below.

With unicast, radio resources (e.g. carrier frequency slices allocated across time slots and spatial layers) are allocated to each device, typically on a delivery-by-delivery basis. In other words, radio resources are allocated per device delivery. However, some devices may be in radio-advantaged conditions (i.e., higher radio metrics such as SNR/SINR/CQI), and, consequently, use fewer radio resources to achieve a given target throughput (i.e., are more spectrally efficient). The use of Massive MIMO or broadcast beams may improve radio conditions of such devices. In contrast, devices on poorer radio channels will end up using more radio resources to achieve the same target throughput desired for delivery of the content in question.

With broadcast, the same set of radio resources is shared across all participating devices (for example, on a cell in a wireless system). Individual per-device radio resource allocation does not happen. Also, a common spectral efficiency level is used for data delivery across a session—to all participating devices. This is typically at a “middling” level (it may even be at a “least common denominator” level)—so that a large enough number of devices may receive the broadcast successfully. (Devices that are radio-disadvantaged enough to not tolerate this target broadcast spectral efficiency level will receive little or none of the content). Hence, a highly spectrally efficient unicasting device (i.e., having better radio conditions, and by itself, achieving throughputs with fewer radio resources) will typically experience a lower spectral efficiency when moved over to broadcast. On the other hand, the radio resource sharing feature of a broadcast raises overall spectral efficiency since more devices are being served using the same quantum of spectrum.

This tradeoff—between drop in per-device spectral efficiency for radio-advantaged users, vs. increased spectral efficiency from resource sharing is a factor to assess while making unicast vs. broadcast choices.

With this approach, the distribution system 10 determines the capacity (e.g., number of PRBs in a 4G/5G system) available to the live stream delivery. This may be a percentage that can be allocated to the broadcast. Based on the required delivery bitrate and capacity allocated to the broadcast, the target spectral efficiency is determined for the particular iteration. Given the target spectral efficiency, a list of devices that are able to participate in the broadcast (i.e., whose radio conditions are at least as good as required to receive delivery at this target spectral efficiency level) is determined. The remaining participating devices will need to receive the real-time or live content delivery via unicast. The net spectral efficiency for this combination of broadcast and unicast is determined (i.e., factoring in throughputs achieved for the broadcast and unicast deliveries, and total spectrum used up. This will be dependent on the target spectral efficiency for the broadcast component, and the spectral efficiency levels used for deliveries to the unicast devices).

The distribution system 10 will perform several iterations of the process, with each iteration factoring in a different percentage of the available spectral capacity being used for the broadcast part of the live stream. For example, the first iteration may assume 0% of capacity used for broadcast (i.e., the live stream is done entirely using unicast deliveries). Subsequent determinations may increase the percentage. The final iteration may factor in all (100%) of the available capacity being applied to the broadcast component of the live stream, i.e., no unicast deliveries for the live stream.

As part of delivery of the content, the content distribution system 10 may choose to opportunistically cache the content in targeted locations, which it retrieves to serve to any given requesting user at that time, in anticipation of future needs for the same content by other users. For example, in one example broadcasting may be consumed in real-time by various uses while intermediate devices or other user devices cache the content for later consumption. Further, the content may be post-positioned in an upstream node in a wireless network (e.g. a PDN Gateway or User Plane Function) but much closer to the user than the content origin server such the content may be delivered to a larger interested population of users from a closer point of access when the system is responding to a first user requesting such content and the system needing to retrieve such content from the content origin.

Referring now to FIG. 7B, the spectrum efficiency module 764 of FIG. 7A is set forth in further detail. In FIG. 7A, a bit rate determination module 770 is used to determine the target throughput. The target throughput may be chosen as the bit rate of the audio/video live stream.

The determinations below are performed in a number of iterations with each iteration factoring in a different (increasing in this example) percentage of the available spectral capacity being used for the broadcast part of the live stream. In this example, the first iteration or start iteration is determined with 0% used for broadcast, which means the live stream is done entirely using unicast deliveries. For a live stream, once the candidate list of “broadcastable” user devices is determined, the next step would be to determine whether a broadcast should be started up for the live stream delivery, the optimum distribution of capacity across broadcast and unicast deliveries, plus the optimum blend of broadcast user group size and unicast user group size. The optimum blend will result in the highest net spectral efficiency.

Each iteration loop determines the broadcast target spectral efficiency for each iteration. First the target spectral efficiency to be used for the broadcast delivery to generate the bitrate, based on spectrum available for broadcast (available spectrum) in this iteration. A broadcast determination module 771 is used for determine the broadcast capacity for each iteration.

Capacity_{Broadcast}=% capacity used for broadcast in this iteration*wireless capacity (e.g., # PRBs*Hz/PRB) available for the live stream delivery.

Using the above, a broadcast target spectral efficiency module 772 determines the broadcast target spectral efficiency by:

Target Spectral Efficiency (bits/s/Hz)=Target Throughput/Capacity_{Broadcast}

A target channel quality level comparison module 773 compares the channel quality (radio metrics) of the potential broadcast only devices to a target channel quality level (target radio metrics). The radio metrics or channel quality level may, for example, be the signal to noise ratio, the signal inference to noise ratio or the channel quality indicator (CQI). The comparison allows only devices that have a high enough radio condition to reliable receive the content to be consider to receive the broadcast signal. A broadcast candidate list module 774 provides a broadcast candidate list for the devices that exceed the target channel quality at the target channel quality level comparison module 773. Other devices that are to receive the live content that do not meet the channel quality level are provided in a unicast candidate list module 775.

Ultimately, a net spectral efficiency is determined. The net spectral efficiency, as further described below, has both a broadcast and unicast component.

For the broadcast component of the live stream, broadcast aggregate throughput module 776 determines an aggregate achievable throughput for the broadcast user group in the current iteration is given by:

Aggregate-ThroughputBroadcast=Target Throughput*(# devices in the current broadcast candidate list potentially participating in the live broadcast+a number of devices where content may be pre-positioned for future consumption*de-rating factor)

The aggregate achievable throughput considers the number of devices that would receive the broadcast real-time, as well as the number of devices that may be interested in future consumption of the content, and in which the content could be opportunistically pre-positioned in an intermediate device or a user device. Using the de-rating factor, a lower weight is applied to the number of devices considered for pre-positioning, as the marginal value of spectrum for real-time use would be higher than that for non real-time (future) use—the latter being determined on a “likelihood of consumption” basis. The lower weight may be applied, for example, by de-rating the number of pre-positioned devices by a factor (less than 1 in value).

The multiplication by the number of devices is used to account for radio resource sharing since with broadcast, the assigned quantity of resources is shared by all participating devices. Broadcasting may use a lower per-device spectral efficiency level than could be used by radio-advantaged devices in unicast mode; but the resource-sharing aspect boosts net spectral efficiency.

For the unicast component of the live stream (unicast user group), the unicast radio resource module 777 determines the overall spectrum used by all of the unicast devices (Capacity_{unicast}). The spectral aspect of each device is taken into consideration since each receives a separate signal that uses a separate piece of spectrum:

For each unicast device such as a user device, the quantum of radio resources required (e.g. spectrum from Physical Resource Blocks or PRBs in an LTE or 5G system) needed to achieve the target throughput for the live stream is determined based on the known spectral efficiency of the device being determined. The spectral efficiency for device-i (spectral efficiency at which the i-th device may receive the unicast delivery, based on its radio conditions) is given by:

Spectrum required(Capacity-RequiredDevice-i)=Target Throughput/Spectral EfficiencyDevice-i

The sum of the resources for unicasting is thus determined by:

Capacity_{unicast}=SUM(Capacity-RequiredDevice-i across all devices in unicast group)

An aggregate throughput module 778 determined the unicast aggregate throughput as:

The unicast aggregate throughput determined at the aggregate throughput module 778 is determined by:

Aggregate-ThroughputUnicast=Target Throughput*Number of Unicast devices

Taking into consideration both the broadcast aspect and the and the unicast aspect of the above, the net spectral efficiency module 779 determines the Net Spectral Efficiency by:

Net Spectral Efficiency=(Aggregate-ThroughputUnicast+Aggregate-ThroughputBroadcast)/(CapacityUnicast+Capacity_{Broadcast})

Thereafter, to ensure that total capacity requirement is within available capacity for the live stream the capacity comparison module 780 performs a comparison of the unicast and broadcast capacities and compares the sum with the available capacity:

When CapacityUnicast+Capacity_{Broadcast}>Total Capacity available, the broadcast/unicast combination from the candidate list for the iteration id discarded. The next iteration of the loop using a different amount of broadcast percentage for the overall capacity is determined. In all, a plurality of blends have their net spectral efficiency determined.

The distribution type module 724 of the distribution system 10 then picks a mode blend from the iterations from above loop. The mode blend may, for example, be provided in terms of a percentage such as: broadcast capacity %, unicast capacity %. The blend that is chosen from the plurality of blends results in the highest net spectral efficiency.

If the selection reflects that a broadcast session needs to be started (i.e., the selected blend has a non-zero broadcast %) at the session control module 732 of FIG. 7A. The session control module 732 instruct the devices from the broadcast candidate list whose SNR/SINR/CQI radio metrics exceed Target Channel Quality level to shift to the broadcast session being set up, in the selected network. The session control module 732 keeps or instructs the non-broadcasting user devices in the unicast candidate list module to remain in or instructs them to receive the content in in unicast mode. Therefore, a blend of unicast receiving user devices and broadcast receiving user devices receive the same content transmission simultaneously in different modes.

The queue 734 is incorporated into the content distribution system 10. The queue 734 may communicate content to user or intermediate devices in a particular order. The order may be based on the interest in a content, popularity of a content, a timing of the popularity, the demand for the content and the like. The queue 734 may be used for pre-positioning content to interested user devices using broadcasting as is described in further detail below.

The above process is described with respect to delivery of a live stream. A similar process performed at the distribution system may be used for migrating a live stream from unicast mode to a broadcast mode. The system may decide to migrate the stream to a broadcast mode in part or in full. That is, the system may continually perform determinations to see if broadcast and/or unicast transmission may be enable for the live stream. A combination of unicast transmissions and broadcast transmissions may be performed. Details of this process are described below. The same is also true for migrating a live stream from a broadcast to unicast. That is, because of various ongoing conditions, the use of unicast rather than broadcast may be desirable.

The system may also be applied to real-time consumption of stored audio/video content. That is, a user may request stored content that is pulled on-demand by a specific user at a specific time. In other words, the actions are not a live event that is time-synchronous to cross a population of users. Even if multiple user devices are viewing the same content simultaneously, grouping the user devices into a live broadcast stream is difficult since their views are not likely to be time-synchronized. When a user starts a stored content viewing stream, the other user devices may pause, rewind or otherwise manipulate the stream so that viewing at the same point is nearly impossible. However, when a user requests a stored content stream to be delivered in real-time, other devices may opportunistically receive the signal using the broadcast mode of the communication system.

Another use of the distribution system is for pre-positioning content in user devices for future consumption. A system that identifies the content generally desired by consumers that broadcast such content over the network in advance of the time it is desired to be consumed by consumers, store such content locally at a consumer premises or within an intermediate device. The final delivery to the user may be performed using a Wi-Fi home network and therefore the medium is constrained. Details of this will be described in further detailed below.

When the broadcast mode is selected or an ongoing transmission is switched from unicast broadcast mode, the distribution system 10 may select one or more out of all the available transmission networks. As mentioned above, various resources from the different networks may be selected by the resource selector module 720. However, the network selector 782 may be used to select a particular network. The best network may be chosen based upon a performance perspective, e.g., the one with the highest spectral efficiency. Multiple paths may also be accessed that are used to achieve the best performance. As mentioned above, a cost perspective may also be used in selecting the best network.

When selecting between different networks, the bandwidth across multiple networks, using multiple pathways available to the user, may be used simultaneously. As will be mentioned in more detail below, underutilized or dormant capacity may also be used for communicating content and live streams to the user devices. That is, when the regular use of a network is low on a consistent basis, the unused capacity may be used for communicating content. When real-time streaming and consumption occurs, the distribution system 10 may choose a broadcast-centric network to deliver the broadcast. For example, a TV network may be used. Further, a low frequency band, such as 600 MHz, may be used because such frequencies communicate data and in longer ranges. Relative to an LTE or 5G network, off-loading various broadcasts to a TV broadcast system may be advantageous. The LTE or 5G wireless network may therefore be used to handle its regular load depending upon the time of day and traffic therethrough.

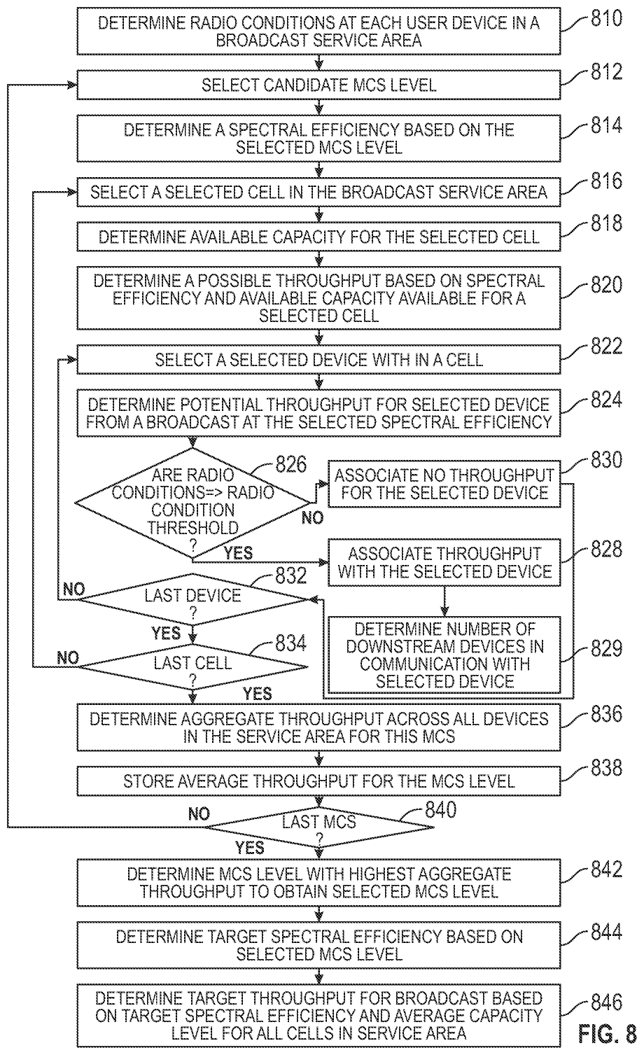

Referring now to FIG. 8, the crowd-sourced distribution concept described above is applicable to unicast and multicast and broadcast scenarios. The local crowd-sourced distribution scheme described herein may augment both unicast and broadcast based content distribution scenarios.

For unicast transmissions, a local crowd-sourced distribution scheme may take a unicast transmission (over the cellular/wide-area network) and “multiply” it across to a multiplicity of proximal devices, to create a net broadcast effect. As a result, one spectrum allocation by the wide-area network gets “leveraged” to service multiple device, which effectively increases the spectral efficiency of the transmission.

As a result, the valuable capacity of the wide-area network is used more efficiently. A given capacity allocation serves more devices. Looking at it conversely, a given net number of devices may be served using less wide-area network spectrum than would otherwise be possible. (This could be dormant network capacity—e.g. for a download/pre-positioning scenario—or live network capacity).

The other consequence is range/coverage extension—enabling devices that have poor radio reception from the wide-area network to receive content from other devices that have better coverage from the wide-area network.

To enable this, devices within close proximity in an area need to organize into a mesh to percolate content down from device to device. The operation into a mesh may be controlled by the content distribution system or may be self-organizing. A self-organizing network algorithm forms a tree of device nodes, based on mutual connectivity (signal strength/signal-noise ratio (SINR)) considerations, to form a local network that maximizes distributive capability. For example, at the top of the tree would be devices that may “hear” the wide-area network well, and also have strong connectivity to “downstream” devices to which they may distribute content. The local network may be formed form various numbers of adjacent local area networks as described above.

The formation of this local distribution topology may be facilitated by the content distribution system in the cloud (based on local connectivity metrics received from devices), or may be orchestrated autonomously by the local devices. Machine learning schemes may be applied to form and re-shape this mesh, as devices move around and conditions change.

A similar scheme may also be applied to a multicast/broadcast stream, to multiply the broadcast effect of the transmission, i.e. to percolate the content to more devices than the originating multicast/broadcast via the wider-area network would be able to do. The originating multicast/broadcast occurs over the wide-area network (for example, using MBMS technology in 4G (LTE) or 5 MBS in 5G). Devices receiving the wide-area broadcast may then distribute the content to locally connected “downstream” devices (e.g. over Wi-Fi).

For the wide-area multicast/broadcast, the content distribution system picks the MCS Level (out of all possible MCS levels) that provides the maximum average throughput across all target devices in the broadcast's Service Area—also adding in the distributive capacity obtainable via local crowd-sourced distribution from the receiving devices to other locally-connected devices. For each candidate MCS Level, we determine the estimated throughput that each device (including devices receiving local distribution) would be able to receive; and hence the average device throughput for that MCS Level. All MCS levels may be cycled through, and pick the MCS level that results in the highest average throughput and use the corresponding spectral efficiency value for the broadcast cycle.

The principle here is that if a high Spectral Efficiency (SE) level for the broadcast is chosen, devices that have radio conditions at or better than needed to receive at that SE level will receive throughput corresponding to that SE. Underlying “downstream” devices may also benefit by receiving locally from these devices that receive the wide-area broadcast. But devices that are in weaker radio states may get little or no throughput. Hence, the “good” devices get high throughputs vs. a significant number of “weaker” devices getting little or nothing.

On the other hand, when a low SE target is chosen, a larger number of devices is covered, but each, including the really “strong” devices, will receive the lower throughput. But now, a larger number of devices may distribute additionally to their locally connected devices.

The system therefore arbitrages across throughput and coverage—high throughput with lower coverage, vs. lower throughput covering a larger number of devices. It's an optimization to find the SE level that provides the best throughput product across all the devices.

In FIG. 8, the content distribution system 10 may use a dynamic approach to set the broadcast parameters. In this example, the content distribution system 10 performs a set of radio resource management determinations to set the throughput for the broadcast. In step 810, the system 10 determines the radio conditions (radio channel quality feedback) from participating devices to determine the effective target spectral efficiency level for the broadcast. For example, signal strength and signal-noise ratio measurements may be used. In wireless systems such as 4G and 5G, it is possible to obtain signal strength and signal-noise ratio metrics specific to unicast and broadcast, i.e., determine how well a device is able to receive unicast signals as well as broadcast signals combined from multiple cells. Additionally, metrics such as latency and jitter may factor in as well. A system using an over-the-top distribution protocol may mange and initiate the content distribution within the local area network or networks by obtaining feedback from devices and reporting the radio conditions they are experiencing. Usable metrics may include signal strength, signal-noise ratio (SNR), signal-interference/noise ratio (SINR), channel quality indicator (CQI) and other related metrics. These types of measurements may be collected by having the participating device collect the radio metrics (e.g., from the modem processing unit in the device) and convey them (over-the-top) to the content distribution system 10 in the cloud. The device, in many ways, provides the best indication because it is able to quantify the precise quality of experience it is receiving. Another way to collect the radio metrics is by deploying a software agent in the radio access network, e.g., at the cell level—for example, in an eNodeB in a 4G system, or a gNodeB in a 5G network. The software agent here provides a variety of network-side measurements, including radio resource usage information, directly to the Service. As is described in more detail below, the system leverages these metrics to derive the appropriate modulation and coding scheme (MCS) level that each device may safely receive the transmission with. The better a device's radio channel, the higher the MCS or Spectral Efficiency level that may be used for transmitting to the device. The target Spectral Efficiency (e.g., in bits/s/Hz) for unicast delivery to a device could be derived from that device's Spectral Efficiency level. The spectral efficiency to be targeted for the broadcast as a whole may be derived by considering the MCS levels applicable to the different devices in the broadcast's target user population. Additionally, metrics such as latency and jitter may be used to further refine DCCP's understanding of Devices' radio conditions, and further fine-tune dormant capacity management.

In FIG. 8 a throughput optimization approach is performed. With the throughput optimization approach, the distribution system in step 810 picks the MCS Level (out of all possible MCS levels) that provides the maximum average throughput across all target devices in the broadcast service area. In step 812 a candidate a candidate MCS level is selected. In step 814 a spectral efficiency based on the selected candidate MCS level is determined. For example, in a 4G or 5G system, spectral efficiency (SE) (bits/s/Hz) may be calculated=((Symbol Rate per subcarrier*bits/symbol)*Coding Rate)/bandwidth (Hz) per subcarrier.

The below determinations are performed for every cell and every device within a cell. In step 816 a selected cell is selected. In step 818, the available capacity for the selected cell is determined. In step 820 the throughput possible (possible throughput) for the selected cell based on the target SE level from step 814 and the capacity available for the broadcast in this cell is set forth by:

Throughput=Spectral-Efficiency (bits/s/Hz)*Capacity-Available (Hz)

In step 822 a selected device within the selected cell is selected for analysis. In step 824 the potential throughputs that each device would be able to receive is determined at the chosen spectral efficiency is determined. In step 826, the radio conditions of the selected device are compared to a radio condition threshold that corresponds to a radio condition needed to receive content at the target spectral efficiency then the throughput for the device is set to that of step 820 (the possible throughput) is associated with the device in step 828. In step 829 a number of devices in communication with the selected device is also determined. That is, certain devices, as described above, may not have radio conditions to receive content from the wide-area network. However, the chosen device in this loop may be in communication with those out-of-reach devices therefore may be included in the reachable devices to increase the system efficiency. The reachable devices are indirectly connected to the wide-area network or within the same local area network. Outside the local area network devices may be in an adjacent local area network and reachable using a mesh scenario.

In step 830 no throughput is associated with the selected device when the radio conditions are not above the radio condition threshold.

In step 832 when the last device has been analyzed, steps 822 through 830 are performed for the other devices in the cell. When the last device is selected in step 832 it is determined whether the last cell has been analyzed. When the last cell has not been analyzed in step 834 steps 816 through 834 are again performed so that all the cells and all the devices within the cells are analyzed based on the capacity of the selected cells.

For each MCS level, step 836 is performed. In step 836 the aggregate device throughput for all the devices within all the cells at the target spectral capacity is determined for each of the candidate MCS levels. In step 838, the aggregate throughput for the MCS level is stored in the content distribution system. In step 838, determined whether the last MCS level has been checked, period. In step 840, when the last MCS level has not been checked, steps 812 through 840 are performed. In step 840 when the last MCS level has been checked, step 842 is performed. Step 842 determines the MCS level with the highest average throughput is determined to obtain the selected modulation and coding stream (MCS) level.

In step 844, the target spectral efficiency is calculated based upon the selected MCS level. In step 846, the target throughput for the broadcast is based on the target spectral efficiency determined in step 844 and an average capacity for all cells in a service area.

In general, if a high spectral efficiency (SE) level for the broadcast is chosen, devices that have radio conditions at or better than needed to receive at that SE level will receive throughput corresponding to the target SE. But devices that are in weaker radio states may get little or no throughput. Hence, the “good” devices get high throughputs vs. a significant number of “weaker” devices getting little or nothing. On the other hand, if a low SE target is chosen to cover a larger number of devices, many devices including the really “strong” devices, will receive the lower throughput.

The method may be applied to specifically selected (discrete) MCS levels, or to a continuum of MCS Levels optimized using a solver, artificial intelligence or machine learning. Optimization schemes involve a tradeoff between applying a higher Spectral Efficiency to a smaller set of target devices (that may receive effectively at that SE level), vs. targeting a lower throughput towards a larger population coverage of target devices.

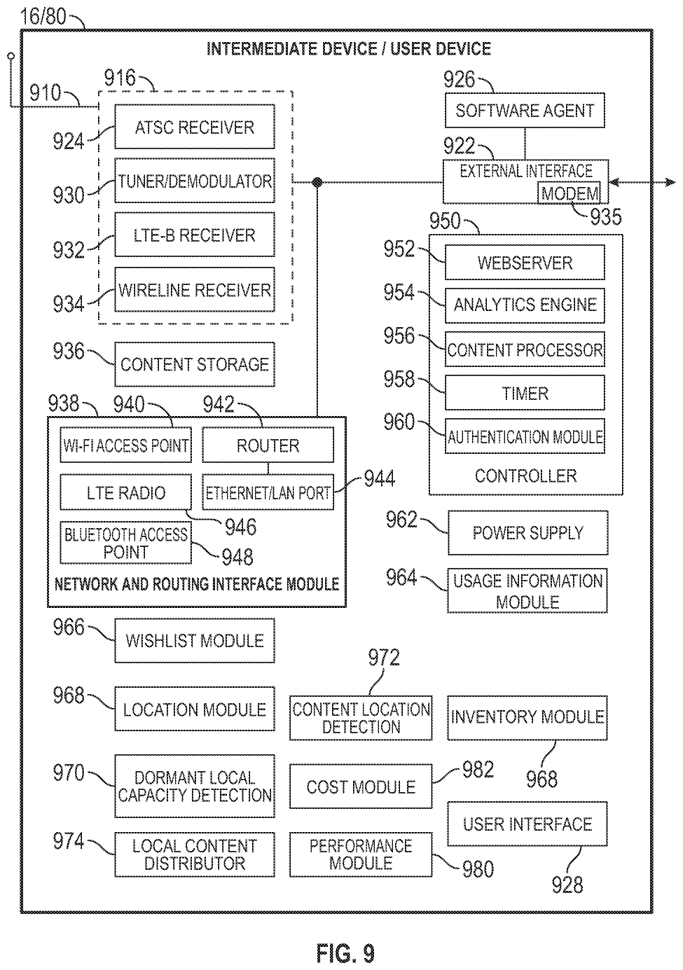

Referring now to FIG. 9, the intermediate device 16 or user device 80 is illustrated in further detail. As mentioned above the user device 80 and the intermediate devices may be referred to as a storage device when storing content therein and a target device when receiving content from another device such as a user device 80 or an intermediate device.

An antenna 910 such as a television antenna or an LTE antenna may be used and interface with the interface 916. The interface 916 may thus be configured to receive LTE-B (eMBMS or MBSFN) or may interface with an ATSC receiver 924 or an LTE-B receiver 932 or for receiving over-the-air television signals with dormant capacity. The ATSC receiver 924 may be an ATSC 3.0 receiver. Thus, the intermediate device 16 may have a tuner demodulator 930 for tuning to and demodulating the signal received over an external input interface 922.

A software agent 926 may communicate to and from the intermediate device 16/user device 80. Certain data may be required to be received in certain formats from different devices. Likewise, data may be communicated to other devices though the software agent 926. Each one of these devices have a software agent 926 that implements the logic to enable the process. The agent 926 detects when the local network is idle, i.e. there is dormant local network capacity available. The agent determines if/where a desired piece of content is available in the local network. The software agent 926 receives orchestration commands from the central content distribution system 10 to trigger local content distribution. The software agent 926 in a target device establishes the Wi-Fi (or other form of) communication to connect to the source device and ultimately effects the content delivery. Many of the functions are set forth specifically below.

The software agent 926 may be an application used for requesting and receiving content for use, such as playback. A user interacts with the software agent 926 or application using the user interface to identify the content to be played back or data requested. More particularly, when the application is in a user device and the content or data is stored in an intermediate device and the user of the user device wants to use the data in non-real time (from the first time when it was stored in the intermediate device), a request for the content is made from the application at a second time. The second time is later than the first time and thus real-time consumption from the point of view of when the content is stored at the intermediate device is not performed. Non-real time consumption of the content or data at a first user device of the plurality of user devices is performed at a second time later than the first time. Later and in real time, the content or data from the intermediate storage device may be communicated to the user device and is consumed at the user application and the user device immediately when requested. The content may be communicated though a local area network from the intermediate device to the requesting user device.

A user interface 928 such as a keyboard, a remote control, a mouse, a touchscreen, a button or buttons, a switch or switch, a dial or dials may be used to communicate to the intermediate device 16 or the user device 80. Content selections, wish list selections control selections may be controlled or indicated though the user interface 928.

The tuner demodulator 930 may also tune and demodulate the L-band signal or an ATSC signal received through the input interface 922. The tuner demodulator 930 may also have error correction therein such as forward error correction (FEC). The LTE-B receiver 932 for receiving external inputs from the interface 922. The LTE-B receiver 932 receives the broadcast signals over an ATSC system. A wireline receiver 934 may be used to receive networking traffic. The wireline receiver 934 may be a USB or HDMI interface.

The external interface 922 may also represent a connection to the Internet 18 through the wired or wireless communication network. That is, the external interface 922 may comprise a modem 935 for communicating content to the intermediate device 16/user device 80.

The intermediate device 16/user device 80 includes content storage 936 that is used to store content therein. The content storage 936 may include solid-state devices or a hard disk drive.

A networking and routing interface 938 may include various network and routing access points. For example, a Wi-Fi access point 940 (AP) may be used to interface with a router 942. However, the router 942 may also be used for wired communications using the Ethernet/LAN port 944. In a local pre-positioning scenario, the target device (target end-user device or storage Device) will typically act as a Wi-Fi client, connecting to the selected source device. The target device makes the required content request (e.g. an HTTP GET request) to the source device. The source device then acts as the Wi-Fi Access Point 940 or Wi-Fi Hotspot, terminating the network side of the Wi-Fi connection. The source device also acts as the local content server for the transaction, i.e. it provides web server processing and returns the requested content to the target device.

The networking and routing interface 938 may include an LTE radio 946 for communicating LTE radio signals from the device. The LTE-B receiver 932, as well as the LTE radio 946, may be incorporated into a signal unit. The intermediate device 16/user device 80 may also communicate using Bluetooth. That is, a Bluetooth access point 948 may be incorporated into the network and routing interface module 938.

The intermediate device 16/user device 80 may include a controller 950. The controller 950 may perform many functions, including as a web server 952, an analytics engine 954 and a content processor 956. Although individual interconnections are not illustrated in FIG. 9, the controller 950 may control the underlying timing and functions of the various modules within the intermediate device. The web server 952 may communicate content from the intermediate device/user device in an IP format to other intermediate devices or end user devices. The controller 950 may also tune to the data at predetermined times as determined by the timer 958. The timer 958 may be synchronized with various other intermediate devices within the system using GPS or internet-based time standard. The content processor 956 tunes to receive the content at predetermined times from a predetermined network/network device as a broadcast, a unicast, direct stream and manages the storage of the content, verifies the integrity of the stored content and receives and manipulates manifest files, which provide instructions for downloading the content. The analytics engine 954 handles the intermediate device/user device analytic functions for the system.

Neighboring intermediate or other devices may also receive and transmit content from the intermediate device 16/user device 80. The network and routing interface 938 may communicate with other intermediate devices for receipt of content, content chunks or missing content at the content storage 936. Missing content may occur when network errors, hardware errors or weather prevent the content from being received at the content storage 936. Communication with other intermediate or user devices may take place using the web server 952 using an internet protocol.

The network and routing interface 938 may communicate a request signal to the communication system provider 12 or the content service provider 90 to request whole content, content chunks or missing content at the content storage 936. The communication system provider may communicate the requested content in streaming manner, or a unicast manner using wide area or dormant local network capacity to the requesting intermediate device. A complete broadcast retransmission may also be performed in response to the request. Retransmission may occur if a significant number of intermediate devices request particular content.

An authentication module 960 may also be included within the controller 950. The authentication module 960 may communicate authentication signals to the communication system provider or for the content service provider so that the devices may intercommunicate properly. An unauthorized device may not be able to receive content from the communication system provider.

The intermediate device 16/user device 80 may also include a power supply 962 for powering the various modules therein.

A usage information module 964 may provide the communication system provider 12 or the content service provider 90 with information as to the usage of various information, content and programming within the intermediate device 16/user device 80. By providing the usage information, content of interest may be communicated to the intermediate device 16/user device 80. Usage information may also be data related to monitoring the utilization of the network that communicates the signals to the intermediate device 16/user device 80. The intermediate device or user device may provide to the distribution system with data regarding the use or downloading of certain content or content genres.

An inventory module 968 stores an inventory of the content stored within the content storage 936. The inventory module 968 may also be used to remove content that has expired per the metadata received with the content. After the content expires, the inventory module 968 removes the content to free space within the content storage 936.

The intermediate device 16/user device 80 may also include a wish list module 966. The wish list module 966 may allow the user of the intermediate device or user device to establish a wish list for content to be received in the future. As mentioned above, the wish list set forth in the wish list module 966 allows the content distribution system 10 to pre-position desired content by the users.

A location module 968 may also be provided in the intermediate device 16/user device 80. The location module 968 may be coupled to a GPS of a mobile device. The location may also be the local area network within which the device is in communication with a router. The location may also include adjacent local area networks to which the device may communicate through the associated router. The location may be a location signal having a location identifier. The location may vary due to movement and thus the delivery of content and the resources associated therewith may be adjusted as mentioned above. In a stationary device, the location module 968 may be configured during setup with an address. Both the wish list module 966 and the location module 968 may be coupled to the content storage 936 for storing the data therein.

The intermediate device 16 or user device 80 may also include a dormant local capacity detection module 970. The dormant local network capacity detection module 970 determines the amount of capacity available within the local area network for communicating content between various devices. The dormant local network capacity is the capacity unused by user traffic. The dormant local network capacity detection module 970 may also determine the local capacity available at adjacent local area networks. This will allow the user or intermediate device to communicate with devices within the local area network and with devices outside the local area network.

A content location detection module 972 detects the location of content within the local area network. By sending out a probe or query signal, other devices within the local area network may communicate the content stored within a content storage device therein. Likewise, the content location detection module 972 may also determine the content available at adjacent local area networks or available through a mesh network. That is, content available at another local area network and the devices therein may be provided through the mesh network based upon router to router or other types of intercommunication with the local area network.

A local content distribution 974 is used to distribute content to other user devices within the network. Upon receiving a request from a user device within the local area network or as commanded from the content distribution system 10, the intermediate device or user device communicates the content the other device. The content may be communicated using an IP format.

A performance module 980 may also be disposed within the intermediate device 16/user device 80. The performance module 980 may monitor the network conditions both upstream and downstream of the device. The performance module 980 may communicate back to the content distribution system 10 a signal that corresponds to the performance feedback or radio metrics of the communication network or networks. An efficiency metric may be determined that corresponds to the efficiency of that portion of the communication network associated with the particular device. The performance module 980 generates a data signal that provides data corresponding to the upstream or downstream efficiency of the network of the system around the particular component of the communication network. The efficiency metric data is communicated to the content distribution system 10. Examples of performance feedback or radio metrics include but are not limited to signal-to-noise ratio (SNR), signal-interference-to-noise ratio (SINR), channel quality indicator (CQI) and other related metrics.

A cost module 982 may also be incorporated into the intermediate device 16/user device 80. The cost module 982 may have a cost associated with the use of the network, a cost associated with the use of the compute, and a cost associated with the use of storage. The cost may vary depending upon the time of day and various system resources. The cost may be provided in monetary terms or in some relative data.

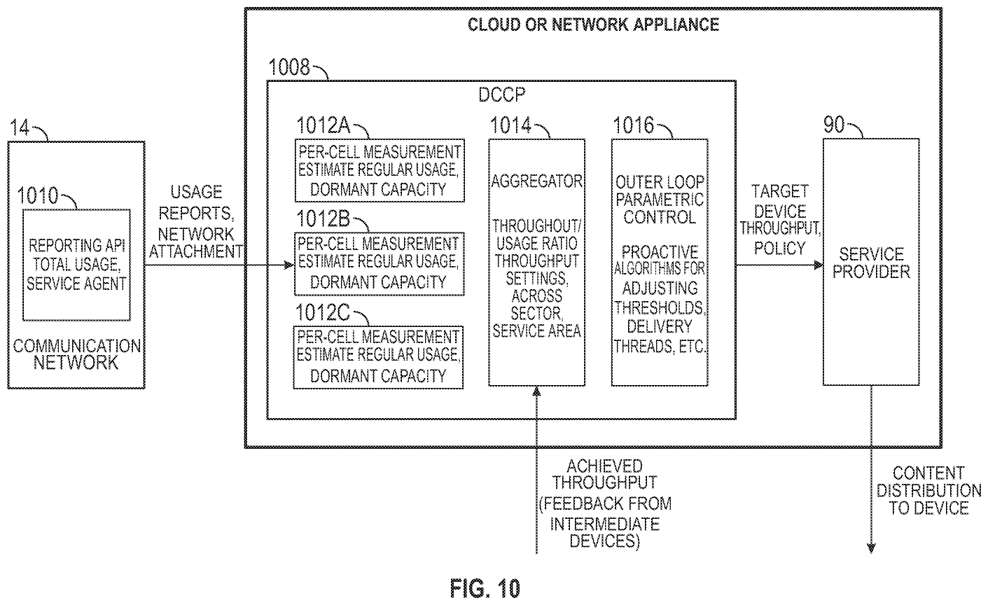

Referring now to FIG. 10, dormant capacity of the wide area network may be capacity available outside of the capacity that is required to serve a similar type of traffic that is increasingly served during peak network use and served less-so during non-peak network use. Dormant capacity may also be capacity available for content pre-positioning at the intermediate devices or user devices and within their content storage and subsequent consumption of that content by users directly from the intermediate devices, and which is not the capacity required for real-time voice and data requests from users or for distribution of content to users and for its immediate consumption. To identify dormant capacity usage patterns of the “primary, non-dormant” network may be reviewed. Dormant capacity may be automatically identified on a real-time basis by receiving information as to the amount of network not being consumed for “primary, non-dormant” use. The identified capacity may be automatically provisioned for use as the dormant capacity in response thereto. “Primary, non-dormant” capacity may run in parallel to “dormant” capacity use such that both are running across the entirety of the resource the entirety of the time but assigning a lower QoS value or identifier to the dormant capacity use so that dormant capacity is only used whenever such resources are not being used by a higher QoS “primary, non-dormant” use such as broadcast communication networks such as cellular, television broadcast, cable television, satellite and the like.

The dormant content delivery system may also be used for delivering device, software and application updates that are associated with the intermediate device or user devices associated with the intermediate device. An inventory list may also include device identifiers, software identifiers and application identifiers. The inventory list may also list the devices associated with the various software and applications.

In FIG. 10, a dormant capacity control protocol (DCCP system) 1008 is used to harvest unused or dormant capacity in networks so that content is stored in the intermediate devices 16 or the other user devices in locations close to where the user consumes the content using an unconstrained medium, such the local area network 310 (Wi-Fi, Ethernet, MoCa, Bluetooth®, cable, etc.). In the example set forth below, the DCCP system 1008 manages dormant radio resources in a wireless cellular network. However, the teachings are equally applicable to other types of networks, such as satellite systems or combinations of different types of networks such as those described above.

The content distribution service of interest (referred to herewith as “service”) provided by the content service provider 90 uses inputs from the DCCP system 1008 to determine how much data may be delivered and pre-position content using dormant capacity. The goal is to leverage as much of dormant capacity as possible, without contending with regular network traffic at all. The system continually adjusts its operational parameters and capacity usage targets, based on metrics received from the network 14 and the intermediate devices 16, to provide elastic dormant capacity management. The desired dormant capacity may vary by time of day and may be determined by input from the operator of the communication system 12. For example, at certain times of the day more dormant capacity may be used as a buffer, such as in rush hour, than other times of the day such as after in the overnight hours.

DCCP system 1008 uses reports from a reporting application interface (API) the network 14 on resource usage to determine network capacity usage—and hence estimate available dormant capacity. The network capacity may be calibrated when no service data is being communicated. This may be performed at various times. In an exemplary cellular network, the reports are communicated using report signals and may by provide data, for example, on physical resource block (PRB) usage within the radio network, received from the network 14 on a per-cell basis. In a cellular network, PRB usage is most effective as a capacity usage measurement metric, since it gives a concrete view of how much of a radio capacity of a cell is being used. DCCP system 1008 uses the metrics to determine the rate at which the service provider may deliver data to devices through the network 14.

The DCCP system 1008 uses resource usage reports to determine the total usage level in the network 14 (referred to herewith as “total usage”). The DCCP system 1008 also determines, from the report data, the level of the capacity of the network being used by regular traffic (e.g., in a wireless network, the percentage of a cell's radio resource blocks used by regular traffic). The regular capacity associated with the communication system provider is referred to as herewith as “regular usage”. The DCCP system 1008 then determines the maximum dormant capacity (in this example, in terms of the percentage of network resources) available for use by the service provider 90. This is the available dormant capacity, which may be expressed as the percentage of the total or overall system capacity, and is referred to herewith as a maximum dormant capacity) Max Dormant Capacity.

Regular metrics from the communication network 14 inform the DCCP system 1008 as to whether the regular traffic load in the network has gone significantly up or down. If network load goes up significantly, DCCP system 1008 may shut down a number of broadcast sessions based on the estimated loading increase. Conversely, new broadcast sessions may be started up if network load is seen to have reduced significantly.

Radio Measurements may be leveraged to fine-tune operation of the system. In addition to collecting and using radio resource usage metrics to manage dormant capacity (as explained so far), DCCP system 1008 may also leverage network quality measurements. For example, signal strength and signal-noise ratio measurements may be used. In some wireless systems, it is possible to obtain signal strength and signal-noise ratio metrics specific to unicast and broadcast, i.e., determine how well the intermediate device may receive unicast signals as well as broadcast signals combined from multiple cells. Additionally, metrics such as latency and jitter may factor in as well.

Measurements may be collected in at least two ways. The first is by having the participating intermediate device 16 collect the radio metrics (e.g., from the modem processing unit in the intermediate device) and conveying them (over-the-top) to the service provider functionality located at the other end of the communication network 14. The intermediate device 16, in many ways, provides the best eyes-and-ears, since it may quantify the precise quality of experience it is receiving.

By deploying a software agents 1012A-1012C in the radio access network, e.g., at the cell level—for example, in an eNodeB in a cellular network. The software agent 1012 here provides a variety of network-side measurements, including radio resource usage information, directly to the service provider 90. Such information may include the regular usage being consumed so that the dormant capacity may be ascertained therefrom.

The DCCP system 1008 leverages the metrics to refine its dormant capacity management. For example, DCCP system 1008 then uses signal strength and or signal-noise ratio measurements to derive the appropriate modulation and coding scheme (MCS) level that the radio network might use to deliver content to a given intermediate device. Using this projected MCS level, DCCP system 1008 may better quantify a target throughput to be used for the intermediate device.

For broadcast, the same scheme may be used to determine the possible MCS level for each participating intermediate device 16 in the service area, derive the average MCS level usable for that population of intermediate devices 16, and then use the MCS level to set a more accurate target throughput for the broadcast period.

Additionally, metrics such as latency and jitter may be used to further refine the understanding at the DCCP system 1008's of the radio conditions of the intermediate devices, and further fine-tune dormant capacity management.

The DCCP system 1008 has an outer-loop parametric control system as illustrated in FIG. 10. Key operational parameters that drive DCCP system 1008 operation such as total usage threshold and Real Usage thresholds for Thread management are either configured (e.g., through a dashboard or programmatic API) or learned. A learning scheme uses historical data to determine day-of-week, time-of-day settings for the parameters. For example, total usage threshold values may be set for different times of the day, and different days of the week, by observing and storing past measurements of total usage, and assessing typical time-of-day, day-of-week total usage values.

In general, the DCCP system 1008 receives per-cell reports with the data described above from the communication network 14 and uses the metrics to estimate dormant capacity and service usage. The aggregator 1014 component then consolidates processing across sectors and service areas (for broadcast) and determines throughput to usage ratios and target throughputs (for intermediate devices or for broadcast periods). Feedback from the intermediate device 16 informs DCCP system 1008 on real throughput achieved by the intermediate devices 16. Finally, an outer-loop policy control module 1016 proactively configures the DCCP system 1008 operation with the parameters that drive its operation. The output from the DCCP system 1008 drives the operation of the service provider 90, informing the service as to when to start/pause/resume content delivery and what the target throughputs to intermediate devices are.

The DCCP system 1008 may be used for determining both broadcast and unicast for the mix of broadcast and unicast provided by the service provider 90. An optimum mix may be provided based upon the perimeters set forth above. The target throughput for a broadcast session using dormant capacity or unicast sessions is set forth.

The radio quality metric such as the signal strength or the signal to noise ratio are used to fine-tune the dormant capacity management and operational settings. Outer loop policy controls dynamically adjust the DCCP system operating parameters based upon feedback from the wireless network. The dynamic adjustment of thresholds such as the upper bound traffic usage threshold or the buffer may be changed. The DCCP for multiple unicast and broadcast cell configuration mode is provided. The system may accommodate a single-cell single carrier sector or sector with multiple carriers with or without carrier aggregation. The DCCP system 1008 for dual connectivity scenarios is enabled. Of course, the present system may be used with a variety of wireless technologies including LTE, 5G and satellite technologies.

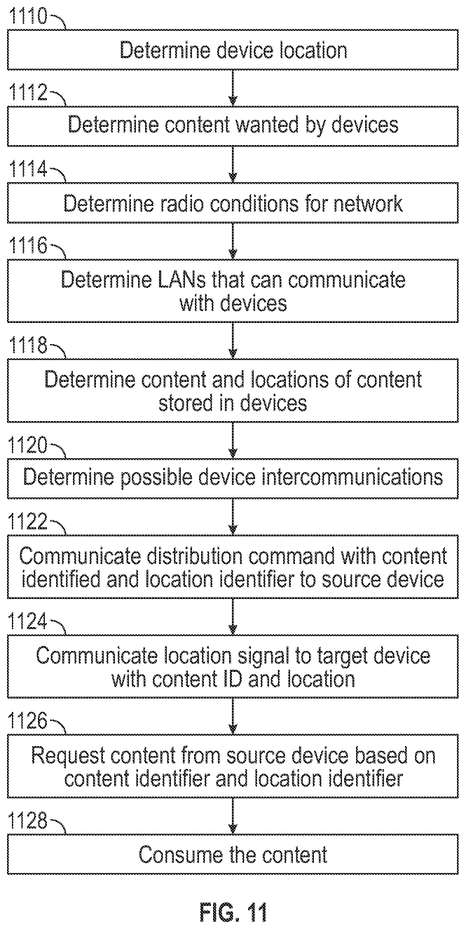

Referring now to FIG. 11, the crowd source content distribution may be controlled by the content distribution system or some features may be controlled by the devices themselves. In FIG. 11, the content distribution system 10 determines the locations of the various devices in step 1110. The location of the devices may be a geographic positioning system. However, the device location may be the location within a local area network. By knowing the location of the local area networks and the devices therein, interconnection of the devices may be achieved as described below. The devices may periodically communicate their locations and the local area networks to which they have access. The devices may also communicate their locations based upon a query signal generated from the content distribution system.

In step 1112, the content wanted by each of the devices within the content distribution system may be determined. The content wanted by the devices may be obtained from a wish list, recommendations or based upon prior viewing. The content wanted may initiate to communication of content from the source storage device to the target storage device.

In step 1114, the radio conditions for the network are determined. The radio conditions refer to the radio conditions that the various devices within the network report back to the network.

In step 1116, the local area networks that may communicate with each of the devices is also set forth. In step 1110, the location of the devices is communicated to the content distribution system. Step 1116 provides the local area networks outside of the local network to which communication may be accomplished using the mesh network techniques described above.

In step 1118, the content and the locations of the content stored in the devices is communicated to the content distribution system. The content and the locations are used to determine the possible device intercommunication in step 1120. The intercommunications allow the content distribution system to command certain devices to communicate the content stored therein to other devices within the network. Machine learning or artificial intelligence may be used to match up the content wanted with the content available based upon the locations. Minimizing the use of the resources within the system may be a factor in choosing the content source and the content target. When the content is within the same network as the target, fewer network resources are used. However, more overall system resources when the content is disposed within adjacent local area networks. However, the use of local area networks is preferred over the use of the wide area network depending upon the conditions.

In step 1122, a distribution command is communicated from the content distribution system to a source device. In step 1124, the content distribution system communicates a location signal to a target device with a content identifier and a location. In step 1126, a request from the target device may be communicated to the source device based on the content identifier and the location identifier. In step 1128, the content is received from the source device and consumed within the source device. The source device may store the content or may play out the content in a streaming manner.

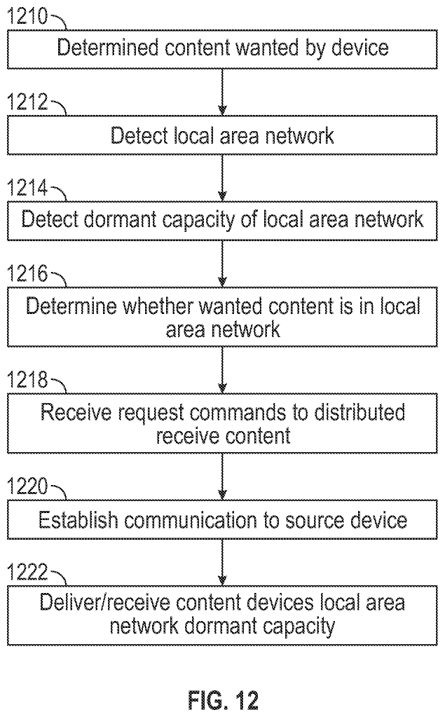

Referring now to FIG. 12, the system may also be partially device driven. That is, the devices may seek the location and control the requesting of content in an autonomous fashion.

In step 1210, the content wanted by the device is determined. That is, the content wanted by the device may be input through a user interface directly or by determination by various types of algorithms. That is, recommendations may also be determined based upon the viewing patterns of the user device.

In step 1212, the local area network to which the user device is connected is determined. Both the local area network or networks and the local area networks connected to the local network may be determined. Several layers deep of connections may be determined.

In step 1214, a dormant capacity of the local area network may be determined. The local area dormant capacity is the capacity available on the local area network that may be available for intercommunicating content between devices within the local area network and outside in adjacent or connected local area networks within the mesh network. In step 1216, it is determined whether the content is available within the local area network. Communicating content within a local area network reduces the amount of overall resources used for communicating the content. In step 1218, when content is within the local area network, the content identifier and the device identifier may be used to request the content from the source device. In step 1220, communication is established between the source device and the target device. In step 1222, the source device communicates the content to the target device using dormant network capacity of the local area network.

In the following descriptions, specific details of the communication signals between target device, the source device and the content distribution is set forth for various delivery scenarios.

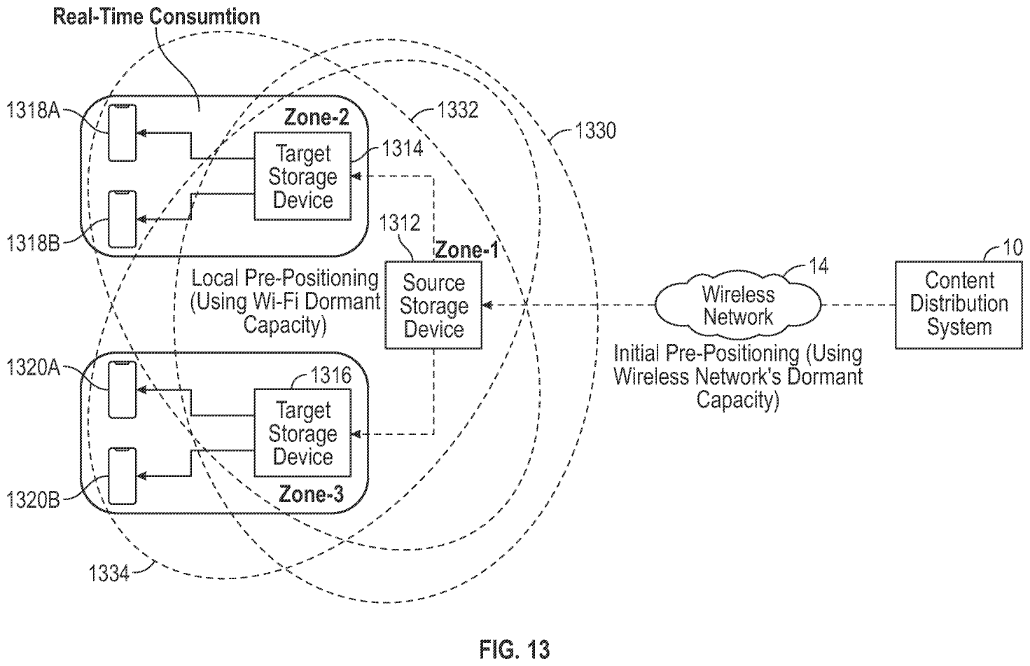

Referring now to FIGS. 13, 14 and 15, local pre-positioning from a source storage device 1312 onto a target storage device 1314, 1316. The following method enables a source storage device 1312 to pre-position content on target storage devices 1314, 1316 that are connected together through one or more local area networks. The storage devices 1312, 1314, and 1316 may be an intermediate device or an end user device.

In FIG. 13, the source storage device 1312 is in the same local area network as the target storage device 1314, 1316. The storage device 1312 may be disposed within a zone 1 such as a home or business local area network. The target storage devices 1314, 1316 may be in communication with the source storage device 1312 through the local area network 1330. Other local area networks may be disposed around zone 2 and zone 3. Local area network 1332 may communicate with target storage device 1314, target storage device 1316, end user devices 1318A, 1318B and source storage device 1312. Local area network 1334 may communicate with target storage device 1314, target storage device 1316, end user devices 1320A, 1320B and source storage device 1312. The method enables the storage device 1312 in zone 1 (e.g., in one household or enterprise), that has been pre-positioned with a piece of content to communicate the content to target storage devices 1314, 1316 in zones 2, 3 (e.g., in other households or enterprises) though the local area network 1330. Dormant local area network capacity may be used. The example avoids the use of the wide-area network 14 resources to distribute the content to the additional devices downstream of the source storage device 1312. The target storage devices 1314 may then communicate the content to their respective end-user devices 1318A and 1318B and 1320A and 1320B though respective local area networks 1332 and 1334, when the users thereof are ready to consume the content. Again, dormant local area network capacity may be used in the communication with the end user devices 1318A, 1318B, 1320A, 1320B.

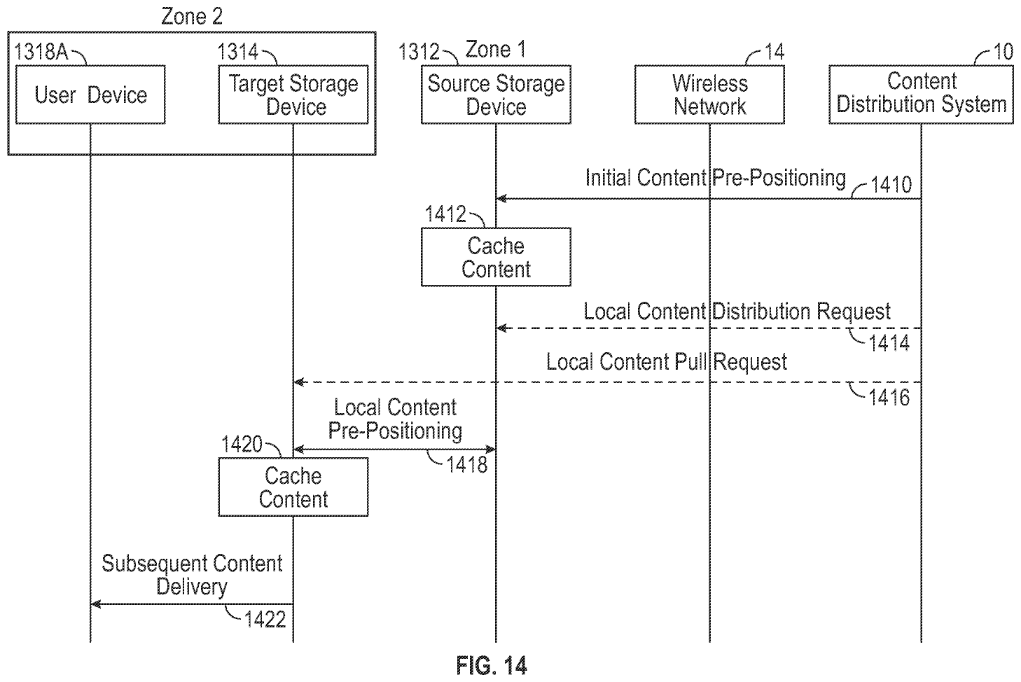

Referring specifically to FIG. 14, a signal flow diagram is set forth. In general, the content distribution system 10 initially pre-positions the content in the source storage device 1312 in zone 1 in step 1410 which acts as cache 1412. For example, the source storage device 1312 could use an HTTP Request to fetch the content from the content distribution system 10). The source storage device 1312 caches the content.

At a subsequent point in time, the content distribution system 10 may generate a distribution request signa00000000000000000l 1414 for the source storage device 1312 to distribute the content to the target storage device 1314. The content distribution system 10 may be cognizant of which devices have connectivity to the source storage device 1312.

In parallel, the content distribution system 10 instructs the target storage device in zone 2 to extract the content from the source storage device 1312 with a pull request signal 1416. The content distribution system 10 may provide precise content asset location data (i.e. file name/URL of the content on the source storage device 1312) in the pull request signal.

The target storage device 1314 connects to the source storage device 1312 over a local connection (e.g. Wi-Fi) and fetches with a pull signal 1418, the content from the source storage device 1312. In this context, the target storage device 1314 may connect as a Wi-Fi client to the source storage device 1312, which may act as a Wi-Fi Access Point (AP). The connectivity could be enabled, in one example, via the use of a hidden SSID configured in the two storage devices by the content distribution system 10. The target storage device 1314 caches the content in the cache 1420.

Note that the source storage device 1312 and target storage device 1314 may communicate with each other to determine the appropriate time at which to pre-position the content in the target storage device. Dormant local capacity (e.g. dormant Wi-Fi capacity) may be used to decide when the local pre-positioning is to be performed. The two devices may negotiate and select a time of low Wi-Fi usage (by their end-user devices) at which to effect the transfer.

At a subsequent time, an end-user device within zone 2 may consume the content from the target storage device 1314 (e.g. stream it from the target storage device) as illustrated by the delivery signal.

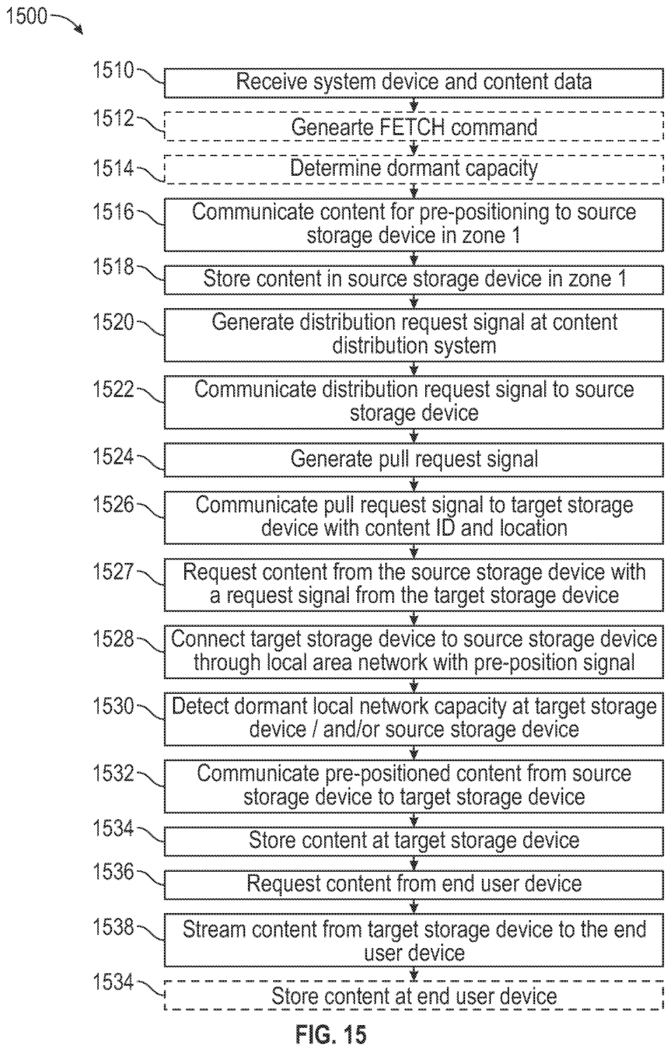

Referring now to FIG. 15, a more detailed description of the method for operating the storage device pre-positioning to another storage device is set forth. In step 1510, the content distribution system receives device and content data. The device and content data was briefly described above as the location of various devices as well as the location of various content and the URLs of the content. In 1512, a fetch command is generated from the content distribution system 10 to the source storage device 1312. In step 1514, dormant capacity may be used to communicate the content from the content distribution system to the source storage device 1312. In step 1516, the content for pre-positioning is communicated from the content distribution system or a storage device associated with the content distribution to the source storage device 1312. The source storage device is in zone 1. In step 1518, the content is stored in the source storage device end zone 1.

In step 1520, a distribution request signal is communicated from the content distribution system to the source storage device in step 1522. The distribution request signal allows the source storage device to communicate with the target storage device 1314. In step 1524, a pull request signal is generated at the content distribution system. The pull request signal may have the URL or other location identifier of the source storage device as well as a content identifier for the content stored at the source storage device. In step 1526, a pull request signal is communicated to the target storage device with a content identifier and the content location to enable communication the source storage device 1312. Based on the content identifier and the location identifier the content, a request signal is communicated from the target storage device to the source device to initiate content communication in step 1527. The communication of the content may be initiated by the content distribution system or may be initiated by the target device based on knowledge previously obtained as to the content location. In step 1528, the target device is connected to the source storage device 1312 using a pre-position signal. In 1530, dormant local network capacity at the target storage device and/or the source storage device is determined. In step 1532, the pre-positioned content is communicated from the source storage device to the target storage device in response to the request using dormant capacity, if dormant capacity is to be used. In step 1534, content is stored at the target storage device 1314.

Eventually, the target storage device 1316 may communicate the content to one of the user devices such as user device 1318A. In step 1536, the content is requested from the end user device 1318A with a request signal.

In step 1538, content is streamed from the target storage device to the end user device. The content may be streamed for real time use. In step 1534, the content may also be stored at the end user device 1318A for subsequent use.

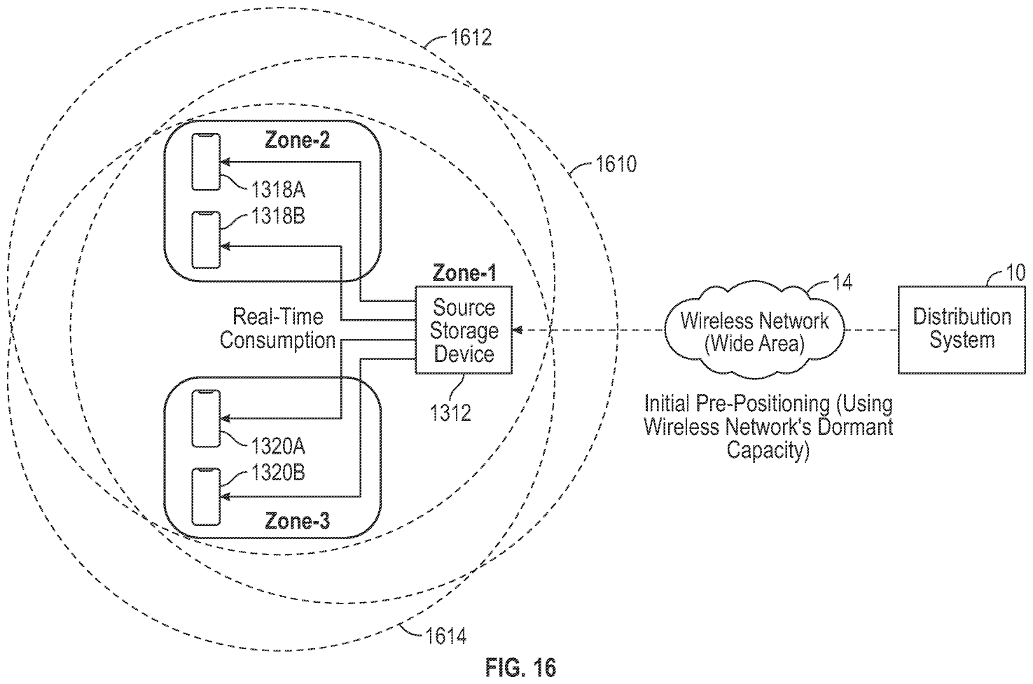

Referring now to FIGS. 16-18 a local crowd-sourced content consumption method is set forth wherein the content is communicated from the source storage device 1312 to the end user devices 1318A, 1318B, 1320A and 1320B. In this example, an end-user device consumes content (e.g. stream content) from any storage device in its vicinity (i.e. that it may “see” or connect to).

FIG. 16 illustrates a local area network 1610 centered around source storage device 1312 and in communication with end user devices 1318A, 1318B, 1320A and 1320B. A local area network 1612 is centered around Zone 2 and is in communication with source storage device 1312 and end user device 1318A, 1318B, 1320A and 1320B. The source storage device 1312 located in zone 1 is able to serve content to end-user devices 1318A, 1318B, 1320A, 1320B in other zones (e.g., zone 2 and zone 3). A local area network 1614 is centered around Zone 3 and is in communication with source storage device 1312 and end user device 1318A, 1318B, 1320A and 1320B. The source storage device 1312 in zone 1 is initially pre-positioned with content from the content distribution system 10. End-user devices 1318A, 1318B, 1320A, 1320B in zone 2 and zone 3 may subsequently stream content from the source storage device 1312 in zone 1.

The ability of end-user devices to consume content from any storage device in their vicinity (not just in the same zone) enables content to be distributed without being communicated through the wide-area (e.g. cellular) network 14 to pre-position or consume (stream) the content. The bandwidth usage (dormant or prime-time capacity) in the wireless network is reduced significantly.

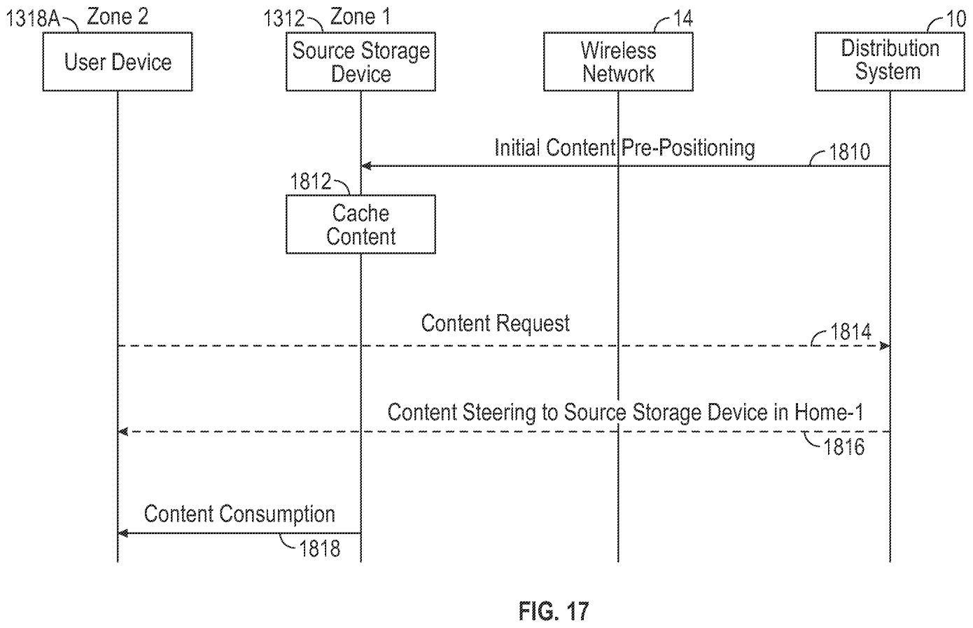

In FIG. 17 an exemplary signal flow diagram for this scenario.

The content distribution system 10 initially pre-positions the content in the source storage device 1312 in zone 1 using a pre-position signal 1710. For example, the source storage device 1312 could use an HTTP request to fetch the content from the content distribution system 10. The source storage device 1312 caches the content in 1712.

At a subsequent time, one of the end user devices such as the end user device 1318A in zone 2 accesses the content distribution system 10 to consume this piece of content using a content request signal 1714.

The content distribution system 10 generates a redirect signal to enable the end-user device 1318 to communicate with the source storage device 1312 in zone 1. The redirect signal may have the content identifier and the URL of the source content storage device 1312.

The end-user device in zone 2 then consumes the content (e.g. streams) with a content consumption signal 1718 from the source storage device 1312 in zone 1 through the local area network associated with both the end user device 1318A and the source storage device 1312. The end-user device 1318A connects to the source storage device 1312 over a local connection (e.g. Wi-Fi) and consumes the content from the source storage device 1312. In this context, the end-user device may connect as a Wi-Fi client to the source storage device 1312, which may act as a Wi-Fi Access Point (AP). The connectivity may be enabled, in one embodiment, using a hidden SSID, configured in the two devices by the content distribution system 10.

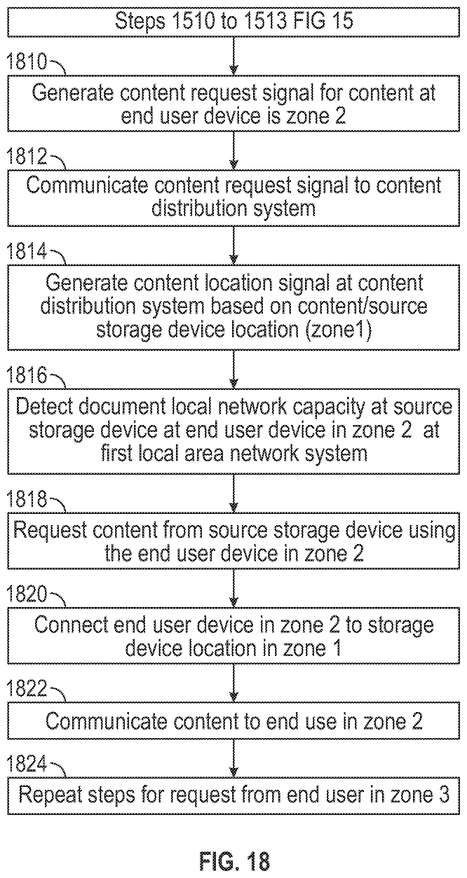

In FIG. 18, steps 1510 through 1518 of FIG. 15 are repeated and therefore are not described further. Steps 1510 through 1518 pre-position the content at the source storage device. In step 1810, a content request signal for content is generated at the end user device in zone 2. In step 1812, the content request signal is communicated to the content distribution system. A content location or redirection signal is generated at the content distribution system based on the content stored at the storage device in zone 1. In 1816, the dormant local network capacity may be detected at the source storage device or the end user device in zone 2 relative to a first local area network.

In step 1818, content from the source storage device is requested using a request signal from the end user device in zone 2. In step 1820, the end user device 1318A is connected in zone 2 to the storage device which is located in zone 1. In step 1822, the content is communicated from the end user device 1318A in this example from the source storage device 1312. In step 1824, steps 1810 through 1822 may be performed for different content or different end user devices located in the same zone or in different zones.

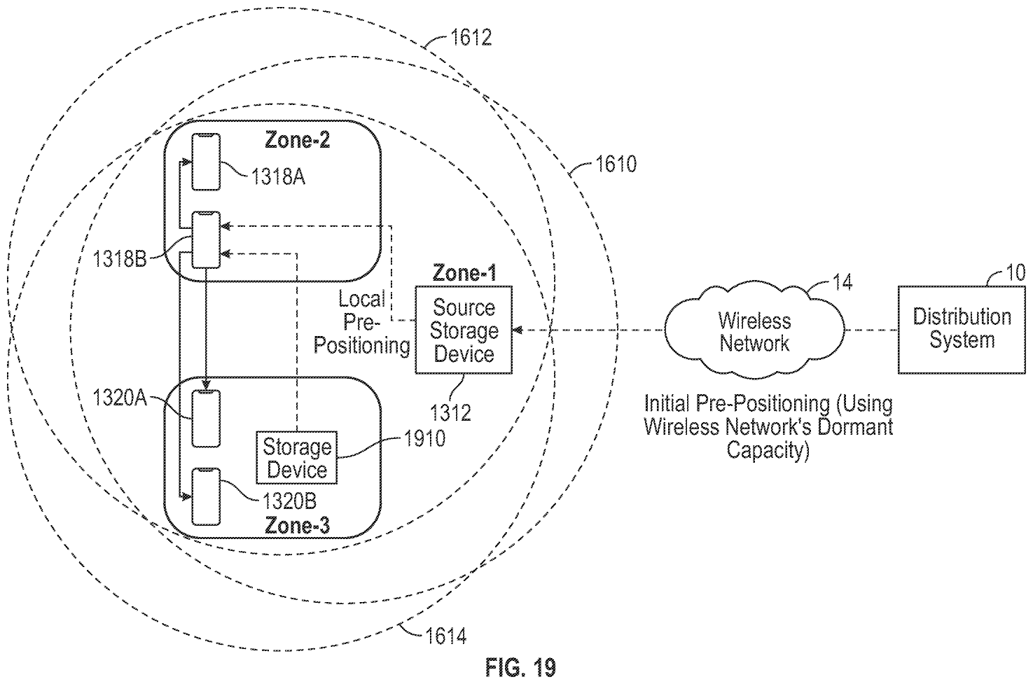

Referring now to FIGS. 19, 20 and 21, local pre-positioning of content to end-user devices is set forth. The storage device 1312 in zone1 that has been pre-positioned with content communicates the content to end user devices 1318A, 1318B, 1320A and 1320B that have connectivity thereto (in the same or a different zone). The method avoids the use of the wide-area network to distribute the content to the additional devices.

In FIG. 19, a source storage device 1312 in zone 1 gets initially pre-positioned with content from the content distribution system 10 through the wide area network 14. The source storage device 1312 then pre-positions one or more end user devices 1318A, 1318B, in this example, in zone 2. The end user devices 1318A can then communicate the content to at least one end user device 1320B (in this example) in zone 2 as well as other user devices 1320A, 1320B in another zone such as zone 3. The system and method may pre-position content in end user devices from “visible” storage devices or other end user devices in any nearby location. Both local streaming from other end user devices in different zones or pre-positioning of content from end user devices in other zones may be performed.

For pre-positioning, the target end user device 1320B in zone 3, in this example, connects as a Wi-Fi client to the source end user 1318B zone 2, which acts as a Wi-Fi access point (AP). End user device 1318B plays the role of a Wi-Fi hotspot. The two devices 1318B, 320B can negotiate and agree on a suitable time, such as when Wi-Fi usage in their respective networks is low in order to determine when to perform user device t user device pre-positioning.

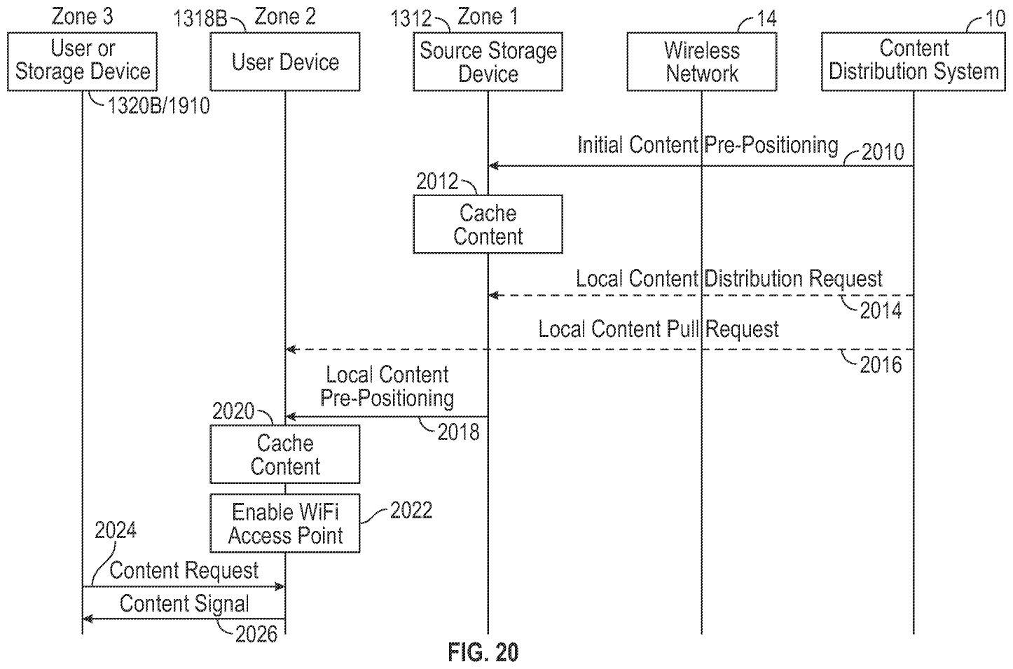

In FIG. 20, the content distribution system 10 initially pre-positions the content in the source storage device 1312 in zone 1 using a pre-position signal 2010. For example, the source storage device 1312 could use an HTTP request to fetch the content from the content distribution system 10. The source storage device 1312 caches the content in cache 2012.

At a subsequent point in time, the content distribution system 10 may generate a request signal 2014 to request the source storage device 1312 in zone 1 to distribute the content to the end user device 1320B in zone 2. The content distribution system 10 is cognizant of which devices have connectivity to the source storage device 1312.

In parallel, the content distribution system 10 instructs the end user 1318 in zone 2 to extract the content from the source storage device 1312 with a pull request signal 2016. The content distribution system 10 may provide precise content asset location information such as the. file name (content identifier) and URL of the content on the source storage device 1312.

The user device 1318B connects to the source storage device 1312 over a local area connection (e.g. Wi-Fi) and fetches the content from the source storage device 1312 with the content signal 2018. In this context, the end user device 1318B may connect as a Wi-Fi client to the source storage device 1312, which may act as a Wi-Fi access point (AP). The connectivity could be enabled, in one embodiment, via the use of a hidden SSID, configured in the two devices by the content distribution system 10. The end user device 1318B caches the content.

Note that the two devices can communicate with each other to determine the appropriate time at which to pre-position the content in the end user device 1318B. Dormant local capacity (e.g. dormant Wi-Fi capacity) may be used to do the local pre-positioning. The two devices may negotiate and select a time of low Wi-Fi usage at which to effect the transfer.

At a subsequent time, the end user device 1318B may communicate the content to other end-user devices 1318A in the same zone or other zones like zone 3. The end user device 1320A in zone 2 may also pre-position the content in other storage devices 1910 or end-user device 1320B within its radio coverage. To perform this, the user device 1318A is enabled as a Wi-Fi access point or hotspot. The user device 1320B or the storage device 1910 generates a content request signal 2024. The content request signal 2024 is communicated to the user device 1318A. A content signal 2026 is communicated from the user device 1318A to the user device 1320B or the content storage device 1920 in response to the content request signal 2024. The user device 1320B may consume the content as it is communicated or store the content therein. The storage device 1910 may storage the content therein.

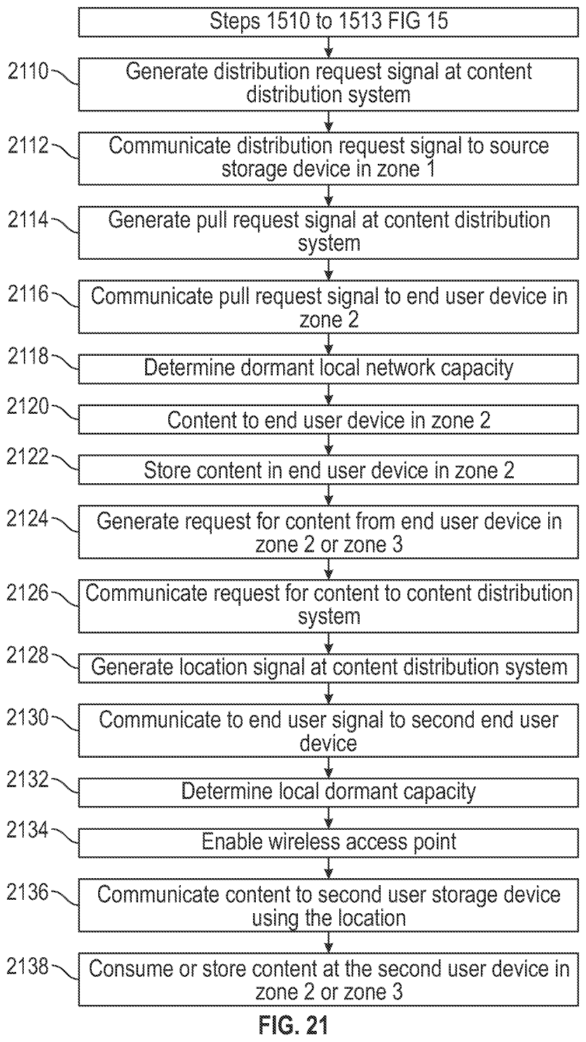

Referring not to FIG. 21, steps 1510-1518 of FIG. 15 are performed. In step 2110, a distribution request signal is generated at the content distribution system. The distribution request signal may comprise a content identifier and a content location such as a URL. In step 2112, the distribution signal is communicated to the source storage device in zone 1. In step 2114, a pull request signal is generated at the content distribution system. The pull request signal is communicated to the end user device in zone 2 in step 2116. In step 2118, the dormant local capacity of the local area network may be determined as an optional step. In step 2120, the content is communicated to the end user device in zone 2. The timing of the communication may take place when negotiated between the end user device and the source storage device based on the dormant local network capacity. That is, when the dormant local network capacity is high, the content may be communicated through the local area network. In step 2122, the content is stored in the end user device in zone 2.

In step 2124, other devices in zone 2 or zone 3 may want the content that was stored in the user device in step 2122. In step 2124, a request for content from an end user device in zone 2 or zone 3 is communicated to the end user device 1318B. The request for content may be communicated to the content distribution system in step 2126. This is an additional step from that illustrated in FIG. 20 because the content distribution system may control the movement of content around the content distribution system. In step 2128, a location signal may be generated at the content distribution system. The content distribution system, as mentioned above, may keep track of the location of the devices and the location of the content within the devices within the system. Both storage devices and end user devices may be monitored in the distribution system. In step 2130, a location signal may be communicated to the second end user device from the content distribution system. In step 2132, content may be requested from the content distribution system at the second user device. In step 2132, the dormant local network capacity may be monitored to determined when to communicate the content from first end user device 1318B to the second end user device 1320B or the content storage device 1910. Step 2132 is an optional signal. In step 2134, the first end user device 1318B may be enable as a wireless access point. In step 2136, the content may be communicated to the second end user device or storage device 1910 based upon the location from the location signal and through the wireless access point.

In step 2138, the content communicated to the second user device 1320B may be consumed such as through streaming. Further, the content may be stored in the second user device or storage device in zone 2 or zone 3.

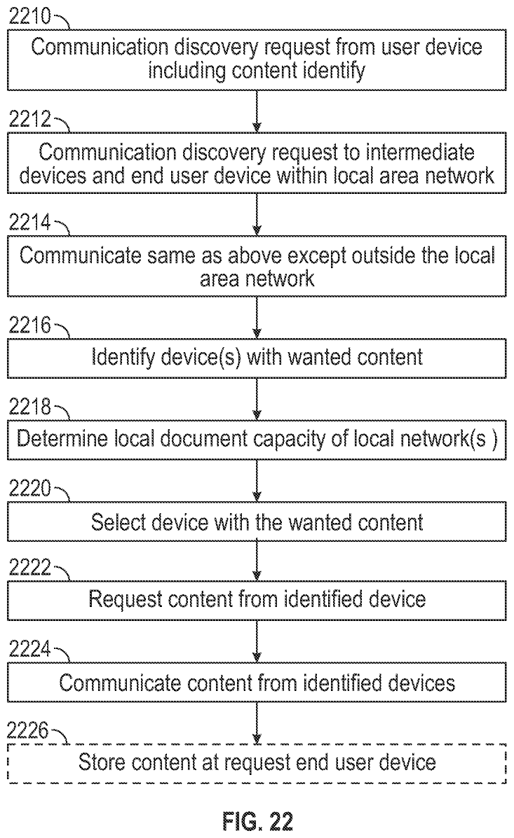

Referring now to FIG. 22, the discovery in identifying of various devices with content and the exchange of content between devices may be performed in different ways. In step 2210, a discovery request signal may be communicated from a device such as but not limited to an end user device or another storage device. The discovery request signal may include a content identifier that identifies the content that is wanted by the requesting end user device. The discovery request signal

In step 2212, the discovery request signal is communicated to another device such as the intermediate device and other end user devices within the local area network. In step 2214, the discovery request signal may be communicated to storage devices such as intermediate devices and end user devices outside the local area network in adjacent local area networks. In step 2216, the device or devices with the wanted content stored therein may be identified. That is, the device or devices with the wanted content may respond to the request with a location identifier. In step 2218, the dormant capacity of the local area networks may be determined. This is an optional step that may be used so that communication of content locally does not interfere with the operation of the wireless local area networks. At step 2220 when more than one device with the wanted content is identified, the device for communicating is selected. Proximity may be one determining factor. How busy or able to communicate is another. Using fewer resources overall (compute power, storage capacity, network capacity, network speed) may also be a consideration.

In step 2222, a request for the content from the identified device is generated from the end user device making the request. In step 2224, the content is communicated from the identified device and communicated to the requesting device through one or more local area networks. In step 2226, the content may be stored at the requesting end user device or consumed by streaming.

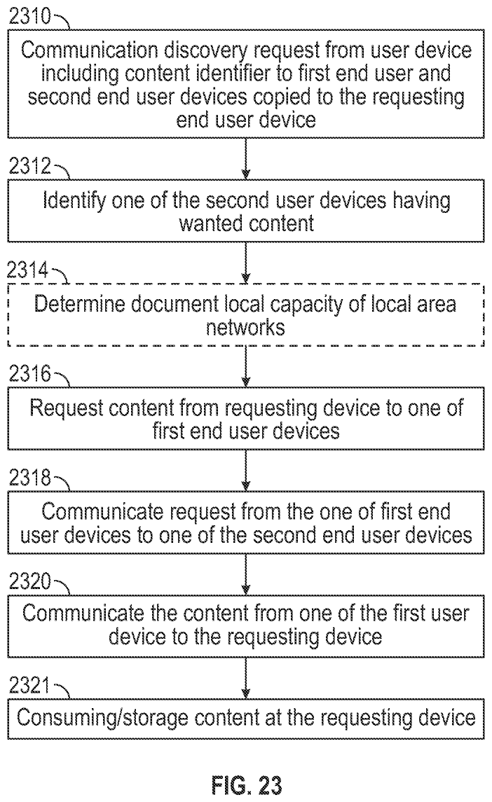

Referring now to FIG. 23, a content discovery request signal may be communicated from a requesting device that includes a content identifier to first end user devices and second end user devices coupled to the requesting end user device. In step 2312, the identity of one of the second end user devices having the wanted content is determined. In step 2314, the dormant capacity of the local area networks may optionally be determined. In step 2316, a request for content from the requesting device to one of the end user devices is generated. In step 2318, the request is communicated from one of the first end user devices to one of the second end user devices. In step 2320, the content is communicated from one of the second end user device to one of the first end user devices. In step 2322, the content is communicated from the one of the first end user devices to the requesting device. In step 2324, the content is consumed or stored at the requesting device. In this manner, groups of end user devices may act as a proxy for the system to allow the content to be accessed deeper within the network.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A method comprising:
receiving and storing a first content at a first storage device;
communicating the first content from the first storage device to a second storage device through a local area network, said second storage device downstream from the first storage device;
storing the first content in the second storage device;
requesting the first content at a first user device; and
communicating the first content from the second storage device to the first user device when requested by the first user device.

2. The method of claim 1 wherein communicating the first content from the first storage device to the second storage device comprises communicating the first content to the second storage device using dormant local network capacity.

3. The method of claim 2 wherein using the dormant local network capacity comprises using available capacity on the local area network that is unused by user traffic.

4. The method of claim 2 wherein using the dormant local network capacity comprises using a separate radio resource.

5. The method of claim 1 wherein communicating the first content to the second storage device comprises communicating the first content to a plurality of downstream storage devices.

6. The method of claim 1 wherein communicating the first content to the second storage device comprises communicating the first content to a plurality of downstream storage devices using dormant local network capacity.

7. The method of claim 1 wherein communicating the first content from the second storage device to the first user device when requested by the first user device comprises communicating the first content from the second storage device to the first user device through a plurality of local area networks when requested by the first user device.

8. The method of claim 1 wherein communicating the first content from the first storage device to the second storage device through the local area network comprises communicating the first content from the first storage device to the second storage device through at least one of Wi-Fi, Bluetooth®, multi-media over coax, ethernet and cable.

9. The method of claim 1 wherein communicating the first content from the first storage device to the second storage device through the local area network comprises communicating the first content from the first storage device to the second storage device using a hidden service set identifier.

10. The method of claim 1 wherein prior to receiving and storing the first content at the first storage device, unicasting the first content to the first storage device.

11. The method of claim 1 wherein prior to receiving and storing the first content at the first storage device, multicasting the first content to the first storage device.

12. The method of claim 1 wherein prior to receiving and storing the first content at the first storage device, broadcasting the first content to the first storage device.

13. The method of claim 12 wherein prior to broadcasting determining a modulation and coding scheme based on an aggregate throughput and a number of downstream devices reachable by first storage device.

14. The method of claim 13 further comprising determining a target spectral efficiency and wherein broadcasting comprises broadcasting the first content to the first storage device based on the target spectral efficiency.

15. The method of claim 13 further comprising determining a target spectral efficiency and wherein broadcasting comprises broadcasting the first content to the first storage device based on the target spectral efficiency and an average capacity in cells of a service area.

16. The method of claim 1 wherein communicating the first content from the first storage device to the second storage device through the local area network comprises initiating communicating the first content from the first storage device to the second storage device through the local area network from the first storage device.

17. The method of claim 1 wherein communicating the first content from the first storage device to the second storage device through the local area network comprises initiating communicating the first content from the first storage device to the second storage device through the local area network from the second storage device.

18. The method of claim 1 wherein communicating the first content from the first storage device to the second storage device through the local area network comprises initiating communicating the first content from the first storage device to the second storage device through the local area network from a content distribution system.

19. The method of claim 18 wherein initiating communicating the first content from the first storage device to the second storage device through the local area network from the content distribution system comprises determining wanted content of the second storage device at the content distribution system and initiating communicating the first content based on the wanted content.

20. The method of claim 1 further comprising communicating a discovery request for wanted content from the first user device within the local area network and generating a response signal from the second storage device when the wanted content is disposed therein.

21. The method of claim 1 further comprising communicating a discovery request for wanted content from the first user device to outside the local area network and generating a response signal from a third storage device when the wanted content is disposed therein.

22. The method of claim 1 further comprising managing communicating the first content from the second storage device using an over-the-top protocol.

23. The method of claim 1 wherein communicating the first content from the first storage device to the second storage device comprises communicating the first content from a first intermediate storage device to a second intermediate storage device through a local network.

24. The method of claim 1 wherein communicating the first content from the first storage device to the second storage device comprises communicating the first content from a first intermediate storage device in a first local area network to a second intermediate storage device in a second local network.

25. The method of claim 1 wherein communicating the first content from the first storage device to the second storage device comprises communicating the first content from a first intermediate storage device in a first local area network to a second intermediate storage device in the first local area network.

26. The method of claim 1 wherein communicating the first content from the first storage device to the second storage device comprises communicating the first content from a first intermediate storage device to a second intermediate storage device through a local network using dormant local network capacity.

27. The method of claim 1 wherein communicating the first content from the first storage device to the second storage device comprises communicating the first content from a first intermediate storage device to a plurality of intermediate storage devices through a local network.

28. The method of claim 1 wherein communicating the first content from the first storage device to the second storage device comprises communicating the first content from a first intermediate storage device in a first local area network to a plurality of intermediate storage devices in a second local area network.

29. The method of claim 1 wherein communicating the first content from the first storage device to the second storage device comprises communicating the first content from a first intermediate storage device in a first local area network to a plurality of intermediate storage devices in the first local area network.

30. The method of claim 1 wherein communicating the first content from the first storage device to the second storage device comprises communicating the first content from a first intermediate storage device to a plurality of intermediate storage devices through a local network using dormant local network capacity.

31. The method of claim 1 wherein communicating the first content from the first storage device to the second storage device comprises communicating the first content from a first intermediate storage device to an end user device through a local network.

32. The method of claim 1 wherein communicating the first content from the first storage device to the second storage device comprises communicating the first content from a first intermediate storage device in a first local area network to an end user device in a second local network.

33. The method of claim 1 wherein communicating the first content from the first storage device to the second storage device comprises streaming the first content from a first intermediate storage device in a first local area network to an end user device in a second local network.

34. The method of claim 1 wherein communicating the first content from the first storage device to the second storage device comprises communicating the first content from a first intermediate storage device in a first local area network to an end user device in the first local area network.

35. The method of claim 1 wherein communicating the first content from the first storage device to the second storage device comprises streaming the first content from a first intermediate storage device in a first local area network to an end user device in the first local area network.

36. The method of claim 1 wherein communicating the first content from the first storage device to the second storage device comprises communicating the first content from a first intermediate storage device to an end user device through a local network using dormant local network capacity.

37. The method of claim 1 wherein communicating the first content from the first storage device to the second storage device comprises communicating the first content from a first intermediate storage device to a plurality of end user devices through a local network.

38. The method of claim 1 wherein communicating the first content from the first storage device to the second storage device comprises communicating the first content from a first intermediate storage device in a first local area network to a plurality of end user devices in a second local area network.

39. The method of claim 1 wherein communicating the first content from the first storage device to the second storage device comprises streaming the first content from a first intermediate storage device in a first local area network to a plurality of end user devices in a second local area network.

40. The method of claim 1 wherein communicating the first content from the first storage device to the second storage device comprises communicating the first content from a first intermediate storage device in a first local area network to a plurality of end user devices in the first local area network.

41. The method of claim 1 wherein communicating the first content from the first storage device to the second storage device comprises streaming the first content from a first intermediate storage device in a first local area network to a plurality of end user devices in the first local area network.

42. The method of claim 1 wherein communicating the first content from the first storage device to the second storage device comprises communicating the first content from a first intermediate storage device to a plurality of end user devices through a local network using dormant local network capacity.

43. The method of claim 1 wherein communicating the first content from the first storage device to the second storage device comprises communicating the first content from a first end user device to a second end user device through a local network.

44. The method of claim 1 wherein communicating the first content from the first storage device to the second storage device comprises communicating the first content from a first end user device in a first local area network to a second end user device in a second local network.

45. The method of claim 1 wherein communicating the first content from the first storage device to the second storage device comprises streaming the first content from a first end user device in a first local area network to a second end user device in a second local network.

46. The method of claim 1 wherein communicating the first content from the first storage device to the second storage device comprises communicating the first content from a first end user device in a first local area network to a second end user device in the first local area network.

47. The method of claim 1 wherein communicating the first content from the first storage device to the second storage device comprises streaming the first content from a first end user device in a first local area network to a second end user device in the first local area network.

48. The method of claim 1 wherein communicating the first content from the first storage device to the second storage device comprises communicating the first content from a first end user device to a second end user device through a local network using dormant local network capacity.

49. The method of claim 1 wherein communicating the first content from the first storage device to the second storage device comprises communicating the first content from a first end user device to a plurality of end user devices through a local network.

50. The method of claim 1 wherein communicating the first content from the first storage device to the second storage device comprises communicating the first content from a first end user device in a first local area network to a plurality of end user devices in a second local area network.

51. The method of claim 1 wherein communicating the first content from the first storage device to the second storage device comprises streaming the first content from a first end user device in a first local area network to a plurality of end user devices in a second local area network.

52. The method of claim 1 wherein communicating the first content from the first storage device to the second storage device comprises communicating the first content from a first end user device in a first local area network to a plurality of end user devices in the first local area network.

53. The method of claim 1 wherein communicating the first content from the first storage device to the second storage device comprises streaming the first content from a first end user device in a first local area network to a plurality of end user devices in the first local area network.

54. The method of claim 1 wherein communicating the first content from the first storage device to the second storage device comprises communicating the first content from a first end user device to a plurality of end user devices through a local network using dormant local network capacity.

55. The method of claim 1 wherein communicating the first content from the first storage device to the second storage device comprises communicating the first content from an end user device to an intermediate storage device through a local network.

56. The method of claim 1 wherein communicating the first content from the first storage device to the second storage device comprises communicating the first content from an end user device in a first local area network to an intermediate storage device in a second local network.

57. The method of claim 1 wherein communicating the first content from the first storage device to the second storage device comprises communicating the first content from an end user device in a first local area network to an intermediate storage device in the first local area network.

58. The method of claim 1 wherein communicating the first content from the first storage device to the second storage device comprises communicating the first content from an end user device to an intermediate device through a local network using dormant local network capacity.

59. The method of claim 1 wherein communicating the first content from the first storage device to the second storage device comprises communicating the first content from an end ser device to a plurality of intermediate storage devices through a local network.

60. The method of claim 1 wherein communicating the first content from the first storage device to the second storage device comprises communicating the first content from an end user device in a first local area network to a plurality of intermediate storage devices in a second local area network.

61. The method of claim 1 wherein communicating the first content from the first storage device to the second storage device comprises communicating the first content from an end user device in a first local area network to a plurality of intermediate storage devices in the first local area network.

62. The method of claim 1 wherein communicating the first content from the first storage device to the second storage device comprises communicating the first content from an end user device to a plurality of intermediate storage devices through a local network using dormant local network capacity.

63. A system comprising:
a first storage device receiving and storing a first content
a second storage device, said second storage device downstream from the first storage device;
said first storage device communicating the first content to the second storage device through a local area network
the second storage device storing the first content;
a first user device requesting the first content; and
said second storage device communicating the first user device when requested by the first user device.
